(19) United States
(12) Patent Application Publication
(10) Pub. No.: US 2021/0249677 A1
(43) Pub. Date: Aug. 12, 2021

(54) INTERMITTENTLY-FLOWABLE ELECTRODES FOR ELECTROCHEMICAL SYSTEMS

(71) Applicant: TECHNION RESEARCH & DEVELOPMENT FOUNDATION LIMITED, Haifa (IL)

(72) Inventors: Matthew SUSS, Nesher (IL); Boris SHVARTSEV, Hadera (IL); Elad HALFON, Maccabim-Reut (IL); Anatoly GOLOVNEV, Leiderdorp (NL)

(21) Appl. No.: 16/973,148

(22) PCT Filed: Jun. 10, 2019
(86) PCT No.: PCT/IL2019/050660

§ 371 Date: Dec. 8, 2020

Related U.S. Application Data
(60) Provisional application No. 62/682,936, filed on Jun. 10, 2018.

(51) Int. Cl. H01M 8/18; C02F 1/469; H01M 4/38; H01M 12/08

(52) U.S. Cl. CPC H01M 8/188; C02F 1/4691; H01M 2004/021; H01M 12/085; H01M 4/38

(57) ABSTRACT

An intermittently-flowable electrode comprising conductive particles and a liquid fluidizing medium in which said conductive particles are suspended, wherein the electrode alternately performs as a flowable electrode and as a self-assembled electrode. Further disclosed are electrochemical devices comprising said intermittently flowable electrode and energy storage, energy harvesting and water desalination systems comprising said devices. Further provided is a method of operating the intermittently-flowable electrode and the electrochemical devices.

### FIELD OF THE INVENTION

The present invention relates to an intermittently-flowable electrode which can perform as a flowable electrode and as a self-assembled electrode, based on user requirements, and be utilized, inter alia, in electrochemical energy storage and/or harvesting and water desalination systems.

### BACKGROUND OF THE INVENTION

Electrochemical flow systems such as flow batteries, supercapacitors and capacitive deionization (CDI) cells are fast-emerging technologies with the potential for highly efficient energy storage and brackish water desalination. Traditional flow battery, supercapacitor, and CDI cells have been revolutionized by the recent advent and application of flowable electrodes, which utilize flowing suspension electrodes (“flowable electrodes”) instead of traditional static film electrodes. Redox flow batteries (RFBs) are fast-emerging technologies with the potential to provide geographically-flexible and highly-efficient grid-scale energy storage. In flow batteries, the use of flowable suspension electrodes comprising conductive particles suspended in electrolyte solution can be used to obtain exceptionally high energy densities, or to enable metal deposition chemistries with a highly scalable flow architecture (Huskinson, B. et al. A Metal-Free Organic-Inorganic Aqueous Flow Battery. Nature 2014, 505 (7482), 195-198).

One common type of a flowable electrode is a slurry electrode. Slurry electrodes have been widely investigated for various flow battery and capacitive deionization applications in the past several years. Slurry electrodes are composed of solid particles typically having a mean particle size of about 10 μm or lower, wherein the particles are entrained by the electrolyte. In electrochemical flow systems electric charges percolate through the flow electrode from the current collector via collisions of the flowing solid particles. However, the performance of flowable electrodes is severely lacking due to sluggish transport of electrons through the electrode, leading to orders of magnitude lower electric conductivity than traditional static electrodes and poor system energy efficiency. For RFBs, capacitors, and CDI cells the sluggish transport of electrons through the discontinuous solid phase of the slurry electrode limits the electrochemical flow systems performance. In RFBs, electric conductivity of slurry electrodes is typically in the order of 10 mS/cm, whereas the ionic conductivity of the electrolyte is often above 100 mS/cm for aqueous systems (Wei, T. S. et al. Biphasic Electrode Suspensions for Li-Ion Semi-Solid Flow Cells with High Energy Density, Fast Charge Transport, and Low-Dissipation Flow. Adv. Energy Mater. 2015, 5 (15), 1-7). CDI slurry electrodes are more limited in material selection, and thus far have achieved electric conductivities in the order of 1 mS/cm (Porada, S. et al. Carbon Flow Electrodes for Continuous Operation of Capacitive Deionization and Capacitive Mixing Energy Generation. J. Mater. Chem. A 2014, 2 (24), 9313-9321). In order to improve performance of the flowable electrodes used in electrochemical flow capacitors, carbon particles were activated by CO₂, thereby forming interconnected porous network having enhanced surface area (J M. Bootaa, K. B. Hatzell, M. Beidaghi, C. R. Dennison, E. C. Kumbur, and Y. Gogotsi. Electrochem. Soc. 2014 volume 161, issue 6, A1078-A1083).

Another type of a flowable electrode that has been investigated for its potential use in electrochemical systems is a fluidized bed electrode. A fluidized bed is formed when a quantity of a solid particulate substance (usually present in a holding vessel) is placed under appropriate conditions to cause a solid/fluid mixture to behave as a fluid. Fluidized bed electrodes are distinguished from slurry electrodes in that they leverage gravity to retard the solid particles relative to the flowing electrolyte. In practice, fluidization requires flow against gravity, and for carbon a particle size of about 100 μm is required to ensure significant gravitational force (Doornbusch, G. J. et al. Fluidized Bed Electrodes with High Carbon Loading for Water Desalination by Capacitive Deionization. J. Mater. Chem. A 2016, 4 (10), 3642-3647).

The concept of “combined electrodes” for RFBs and CDI cells which combine a dilute slurry and dense fluidized bed has been recently introduced. Combined electrodes achieved high electric conductivity when compared to the slurry or fluidized bed components alone (Cohen, H. et al, Suspension Electrodes Combining Slurries and Upflow Fluidized Beds. ChemSusChem 2016, 1-5; International Patent Application No. WO 2018/011787).

Examples of the use of flowable electrodes in various electrochemical systems can be found in the following patents: U.S. Pat. No. 9,583,779 discloses energy storage devices comprising at least one flowable electrode, wherein the flowable electrode comprises an electroactive metal sulfide material suspended and/or dissolved in a carrier fluid; U.S. Pat. No. 9,171,679 discloses flow capacitors having at least one electrode comprising a non-stationary solid or semi-solid composition comprising supercapacitive particles and an electrolytic solvent in electrical communication with at least one current collector, and energy is stored and/or released by charging and/or discharging the electrodes; and U.S. Pat. No. 8,722,227 discloses redox flow devices comprising at least one of the positive electrode or negative electrode-active materials is a semi-solid or is a condensed ion-storing electroactive material.

Flowable electrodes employed in electrochemical flow systems are typically operated utilizing two different flowing modes: a continuous or an intermittent flow mode. In the continuous mode the flowable electrode suspension is continuously circulated through the system and therefore is only partially charged and/or discharged during its residence time in the electrode compartment. In the intermittent mode a single cell volume of semisolid flowable electrode is pumped into the cell, completely charged or discharged under static conditions, then being displaced by a new volume of fresh semi-solid electrode (Duduta, M. et al, Semi-Solid Lithium Rechargeable Flow Battery. Adv. Energy Mater. 2011, 1 (4), 511-516). The intermittent and the continuous flowing modes of electrochemical flowing systems have many disadvantages affecting the performance of said systems, including, inter alia, high mass transport limitations in the static operating mode, and low utilization of active material in the continuous mode. In both flowing modes, the systems suffer from reduced efficiency and lower energy density/capacitance.

Despite the promise of the flowable electrodes, the electric conductivity of such structures is at present too low for CDI or RFB real-life applications and limits the power density and desalination rate achievable with flowable electrodes compared to what can be achieved with solid static traditional electrodes.

There remains, therefore, an unmet need for highly conductive electrodes which can enable high performance of electrochemical flow systems and combine the advantages of static and flowable electrodes.

### SUMMARY OF THE INVENTION

The present invention provides an intermittently-flowable electrode, wherein the electrode can alternate between two operating states: a flowable disassembled state and a static self-assembled state. The electrode in the flowable state can be in a form of a fluidized bed electrode or a slurry electrode, while in the static or self-assembled state the electrode can be in a form of a packed bed or agglomerated electrode. The intermittently-flowable electrode of the present invention comprises conductive micro and/or nanoparticles suspended in a fluidizing medium. Said novel flowable electrode can be used, inter alia, in electrochemical energy storage and/or harvesting systems, and water desalination systems. The intermittently-flowable electrode can alternate between said at least two modes by controlling the flow velocity of the electrode. Advantageously, the switching between the operating modes does not require suspending the flow of the fluidizing medium, such that the fluidizing medium can circulate through the electrode during its entire operation time.

The present invention is based in part on the unexpected finding that by varying the flow velocity of the fluidizing medium, a single flowable electrode can be intermittently altered between the flowable state and the static packed state, affording for about three orders of magnitude rise in electrode conductivity. When the flow of the fluidizing medium is above the minimum fluidization velocity of the electrode, the intermittently-flowable electrode performs as a fluidized bed electrode or a slurry electrode. As explained hereinabove, the fluidized bed electrodes comprise solid particles which flow is retarded relative to the flowing fluidizing medium. When the flow of the fluidizing medium is below the minimum fluidization velocity, the net gravitational force overcomes hydrodynamic drag forces, and the particles self-assemble to form a static packed bed structure, wherein the fluidization medium flows between largely stationary particles. Said transition between different operating modes significantly increases the electrical conductivity of the electrode, which is orders of magnitude higher than in the previously reported flowable electrodes. In particular, the conductivity of the intermittently-flowable electrode utilized in the self-assembled mode was over 10,000 mS/cm, which is higher by about three orders of magnitude than that of the regular fluidized bed electrodes and by at least two orders of magnitude than that of the flowable electrodes previously known in the art. Since the flow velocity of the system can be easily and promptly controlled in real time, the present invention provides a dual-mode electrode which can transform between operating modes in less than about 60 seconds without the need for performing significant changes to the electrochemical system in which the electrode is employed. It has further been found that the minimum fluidization velocity value can be fine-tuned in accordance with the requirements of a specific electrochemical system by varying ionic conductivity of the fluidizing medium.

It is to be emphasized, that the intermittently-flowable electrode of the present invention allows the fluidizing medium to be continuously circulated through the electrochemical system, even during the static self-assembled operating mode. It has not been previously realized that a single flowable electrode can be assembled to act both as a flowable electrode and a static electrode. To the best of the inventors' knowledge, prior publications in the art were directed to an electrode operating in a continuous mode and performing solely as a fluidized bed or slurry electrode. The intermittently-flowable electrode of the present invention thus overcomes the deficiencies of the previously known flowable electrodes by increasing the capacitance and overall energy efficiency of the electrochemical systems as compared to the flowable electrode operated in continuous mode and reducing mass transport limitations as compared to the use of the flowable electrode in an intermittent mode. The intermittently-flowable electrode according to the principles of the present invention therefore combines the advantages of the flowable electrodes with the advantages of static solid electrodes. In particular, the intermittently-flowable electrodes of the invention provide an enhanced amount of electroactive species available in redox or capacitive reactions, efficient electronic and ionic transport between said species, and convenient operation.

The present invention further provides electrochemical devices and systems comprising at least one intermittently-flowable electrode, for electrochemical energy storage and/or harvesting, and water desalination applications. Utilizing the advantageous electrodes of the present invention in electrochemical energy storage systems can provide higher power densities and efficiencies, while water desalination systems comprising said intermittently-flowable electrodes can achieve higher desalination rates and suffer from lower energy losses, compared to the presently existing electrode technologies.

Thus, according to one aspect, there is provided an intermittently-flowable electrode comprising an electrode compartment comprising conductive particles and a liquid fluidizing medium in which said conductive particles are suspended, wherein the electrode has at least a first operating mode, in which the electrode is in a form of a flowable electrode and a second operating mode, in which the electrode is in a form of a self-assembled electrode, wherein the liquid fluidizing medium flows through the electrode compartment in both the first operating mode and the second operating mode.

According to some embodiments, in the first operating mode the suspended conductive particles are in a disassembled state.

According to some embodiments, the flowable electrode is selected from a fluidized bed electrode and a slurry electrode. In certain embodiments, the flowable electrode is a fluidized bed electrode.

According to some embodiments, the intermittently-flowable electrode is configured to transition between the first operating mode and the second operating mode in response to the change in the flow rate of the fluidizing medium.

According to some embodiments, a transition between the first operating mode and the second operating mode is defined by a minimum fluidization velocity of the electrode. In certain embodiments the electrode is in the first operating mode when the flow of the fluidizing medium is above the minimum fluidization velocity and in the second operating mode when the flow of the fluidizing medium is below the minimum fluidization velocity. According to additional embodiments, the minimum fluidization velocity for the transition from the second operating mode to the first operating mode is higher than for the transition from the first operating mode to the second operating mode. In further embodiments, the minimum fluidization velocity for the transition from the second operating mode to the first operating mode is higher than for the transition from the first operating mode to the second operating mode by least about 10%. In still further embodiments, the minimum fluidization velocity is above about 1 μm/s.

According to some embodiments, the liquid fluidization medium flows through the electrode compartment in a non-horizontal direction.

The conductive particles can comprise a material selected from the group consisting of metal, metal alloy, metal carbide, metal nitride, metal oxide, metal silicide, carbon, polymer, ceramics, and any combination thereof. Each possibility represents a separate embodiment of the invention.

In some embodiments, the conductive particles are metal or metal alloy particles. In further embodiments, the metal is selected from the group consisting of Cu, Zn, Al, Si, Sc, Ti, V, Cr, Mn, Fe, Co, Ni, Ga, Ge, Y, Zr, Nb, Mo, Tc, Ru, Rh, Pd, Ag, Cd, In, Sn, Sb, Te, Hf, Ta, W, Re, Os, Ir, Pt, Au, Tl, Pb, Bi, Po and alloys and combinations thereof. Each possibility represents a separate embodiment of the invention. In some exemplary embodiments, the metal is copper (Cu). In additional exemplary embodiments, the metal is zinc (Zn).

In some embodiments, carbon is selected from the group consisting of activated carbon, carbon black, graphitic carbon, carbon beads, carbon fibers, carbon microfibers, fullerenic carbons, carbon nanotubes (CNTs), multi-walled carbon nanotubes (MWNTs), single-walled carbon nanotubes (SWNTs), graphene sheets or aggregates of graphene sheets, and materials comprising fullerenic fragments and any combination thereof. Each possibility represents a separate embodiment of the invention.

According to some embodiments, the mean particle size of the conductive particles ranges from about 0.1 μm to about 5000 μm. In further embodiments, the mean particle size of the conductive particles ranges from about 1 μm to about 500 μm.

According to some embodiments, the conductive particles are present in a form of agglomerates. According to some embodiments, the conductive particles in at least one of the first operating mode and the second operating mode are present in a form of agglomerates.

According to some embodiments, the aspect ratio of the conductive particles or the agglomerates thereof ranges from about 1:1 to about 1000:1. In further embodiments, the aspect ratio of the conductive particles or the agglomerates thereof ranges from about 2:1 to about 10:1.

According to some embodiments, the conductive particles have an activated surface. In further embodiments, the surface of the conductive particles is activated by a method selected from the group consisting of acid treatment, plasma treatment, UV radiation, addition of functional surface groups, and combinations thereof. Each possibility represents a separate embodiment of the invention.

The conductive particles can have a roughness ranging from about 10 nm to about 10 μm.

In some embodiments, loading of the conductive particles in the electrode compartment is at least about 1% wt.

According to some embodiments, the conductive particles are interconnected by cohesive interparticle forces in the second operating mode.

The fluidizing medium can be selected from the group consisting of an aqueous electrolyte, an organic electrolyte, and brackish water. Each possibility represents a separate embodiment of the invention.

According to some embodiments, the electric conductivity of the electrode in the second operating mode is at least one order of magnitude higher than the conductivity thereof in the first operating mode. According to further embodiments, the electric conductivity of the electrode is lower than about 10 mS/cm in the first operating mode and/or is at least about 100 mS/cm in the second operating mode.

According to some embodiments, the electrode compartment is in a form of a flow channel being in fluid flow connection with at least one tube. The electrode compartment can further be formed by at least one of a current collector and a separator.

According to some embodiments, the electrode compartment comprises copper particles, wherein the mean particle size of said copper particles ranges from about 1 to about 150 μm. According to further embodiments, the electrode compartment comprises copper particles, wherein the mean particle size of said copper particles ranges from about 1 to about 50 μm. According to some related embodiments, the fluidizing medium comprises an electrolyte having an ionic conductivity ranging from about 0.1 to about 200 mS/cm.

According to some embodiments, the electrode compartment comprises zinc particles, wherein the mean particle size of said zinc particles ranges from about 20 to about 200 μm.

According to another aspect of the invention there is provided an electrochemical device, comprising: a first current collector; a second current collector; at least one separator; and at least one intermittently-flowable electrode according to the various embodiments presented hereinabove, the electrode being positioned between said first or second current collectors and the separator; and at least one tube in fluid-flow connection with the electrode compartment.

The separator can be selected from the group consisting of a membrane, gasket, spacer, salt bridge, and any combination thereof. Each possibility represents a separate embodiment of the invention.

In yet another aspect, there is provided an energy storage and/or harvesting system comprising the aforementioned electrochemical device; and at least one external storage tank, being in fluid flow connection with the at least one tube, wherein the storage tank is configured to store the conductive particles and/or the fluidizing medium and to deliver the conductive particles and/or the fluidizing medium to the at least one tube prior to the electrochemical operation of the system.

According to some embodiments, the energy storage and/or harvesting system further comprises at least one solid electrode. According to additional embodiments, the energy storage and/or harvesting system comprises at least two intermittently-flowable electrodes and at least two tubes.

In some embodiments, the fluidizing medium comprises an electrolyte. The electrolyte can be aqueous or organic. Each possibility represents a separate embodiment of the invention.

In some embodiments, the energy storage and/or harvesting system is configured in a form selected from a redox flow battery (RFB), electrochemical flow supercapacitor or a capacitive mixing system. The flow battery can be selected from the group consisting of a zinc-bromine flow battery, hydrogen-bromine flow battery, quinone-bromine flow battery, vanadium-bromine flow battery, all quinone flow battery, all-iron flow battery, vanadium redox flow battery, lithium-ion flow battery, lithium-sulfur flow battery, sodium ion flow battery, sodium-sulfur flow battery, lead-acid flow battery, and nickel metal hydride flow battery. Each possibility represents a separate embodiment of the invention.

In yet another aspect, there is provided a water desalination system comprising the aforementioned device, wherein the separator is an ion-permeable membrane and the system further comprises a feed tank comprising a mixing vessel, which is in fluid flow connection with the at least one tube and is configured to mix the fluidizing medium with the conductive particles.

In some embodiments, the fluidizing medium comprises a feed solution.

In some embodiments, the water desalination system is configured in a form of a Capacitive Deionization (CDI) system, comprising at least two intermittently-flowable electrodes, at least two tubes and at least two separators.

In still another aspect, there is provided a method of operating the intermittently-flowable electrode or the electrochemical device comprising the intermittently-flowable electrode according to the various embodiments hereinabove, the method comprising:

flowing the liquid fluidizing medium through the electrode compartment at a first superficial velocity;

increasing a superficial velocity of the liquid fluidizing medium above the minimum fluidization velocity of the electrode, thereby inducing electrode operation in the first operating mode; and/or

reducing the superficial velocity of the liquid fluidizing medium below the minimum fluidization velocity of the electrode, thereby inducing electrode operation in the second operating mode.

According to some embodiments, the method further comprises applying electrical potential to the intermittently-flowable electrode.

According to some embodiments, the method further comprises applying mechanical vibration to the electrode compartment following electrode operation in the second operating mode.

It is to be understood that any combination of each of the aspects and the embodiments disclosed herein is explicitly encompassed within the disclosure of the present invention.

Further embodiments and the full scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE FIGURES

Some embodiments of the invention are described herein with reference to the accompanying figures. The description, together with the figures, makes apparent to a person having ordinary skill in the art how some embodiments may be practiced. The figures are for the purpose of illustrative description and no attempt is made to show structural details of an embodiment in more detail than is necessary for a fundamental understanding of the invention. For the sake of clarity, some objects depicted in the figures are not to scale.

FIG. 1A schematically illustrates the cross-sectional view of the intermittently-flowable electrode according to some embodiments of the invention, including electrode 100a being in the first operating mode and electrode 100b being in the second operating mode.

FIG. 1B schematically illustrates the cross-sectional view of the intermittently-flowable electrode being formed between a current collector and a separator, according to some embodiments of the invention, the electrode being in the first operating mode.

FIG. 1C schematically illustrates the cross-sectional view of the electrochemical device comprising two intermittently-flowable electrodes, a current collector and a separator, according to some embodiments of the invention, the electrodes being in the first operating mode.

FIG. 2 depicts a photograph of the rise of a fluidized bed consisting of copper metal particles in deionized (DI) water as it initially enters the four-electrode measurement cell.

FIG. 3A depicts a photograph of the intermittently-flowable electrode while in the flowable state.

FIG. 3B depicts a photograph of the intermittently-flowable electrode while in the static state.

FIG. 4A depicts the electric conductivity measurements of the intermittently-flowable electrode comprising copper particles during three consecutive velocity cycles. Solid lines show data taken during downscans of velocity beginning at 7 mm/s and ending at 1.5 mm/s, while dashed lines represent data taken during upscans from 1.5 mm/s to 7 mm/s, for first (▴), second (●), and third (▪) scans.

FIG. 4B depicts the measured impedance of the intermittently-flowable electrode comprising copper particles, in the flowable state (flow rate of 6.9 mm/s, black diamonds), and in the static state (flow rate of 1.5 mm/s, gray diamonds).

FIG. 4C depicts the electric conductivity measurements of the intermittently-flowable electrode comprising copper particles for different values of fluidizing medium ionic conductivity. Solid lines show data taken during downscans of velocity and dashed lines represent data taken during upscans, in fluidizing mediums having ionic conductivity of 0.05 mS/cm (♦), 0.97 mS/cm (●), and 35.3 mS/cm ( [symbol] ).

FIG. 5A depicts an optical microscope image of the pristine conductive particles of the intermittently-flowable electrode suspended in deionized water, wherein the fluidizing medium has ionic conductivity of 0.02 mS/cm.

FIG. 5B depicts an optical microscope image of the conductive particles of the intermittently-flowable electrode of FIG. 5A following cycling experiment, which results are shown in FIG. 4C, wherein the fluidizing medium has ionic conductivity of 0.97 mS/cm.

FIG. 5C depicts an optical microscope image of the conductive particles of the intermittently-flowable electrode of FIG. 5B following cycling experiment, which results are shown in FIG. 4C, wherein the fluidizing medium is diluted to ionic conductivity of 0.05 mS/cm.

FIG. 5D depicts an optical microscope image of the conductive particles of the intermittently-flowable electrode of FIG. 5C following cycling experiment, which results are shown in FIG. 4C, wherein the fluidizing medium is concentrated by addition of NaCl salt to increase ionic conductivity thereof to 35 mS/cm.

FIG. 5E depicts the measured particle size distribution of the conductive particles presented in FIGS. 5A-5D, wherein volume fraction represents the volume of particles characterized by a specific diameter (using a sphere equivalent volume) out of the entire volume of particles measured.

FIG. 6 depicts the electric conductivity measurements of the intermittently-flowable electrode comprising zinc particles during two consecutive velocity cycles.

FIG. 7 depicts a charge-discharge cycle of a zinc-bromine flow battery comprising the intermittently-flowable electrode as a zinc electrode.

### DETAILED DESCRIPTION OF THE INVENTION

The present invention provides an intermittently-flowable electrode, wherein the electrode can perform as a flowable electrode and as a static electrode depending, for example, on the flow velocity (also termed herein “flow rate” and “superficial velocity”) of the fluidizing medium in which the conductive particles assembling the electrode are suspended. When the flow rate of the fluidizing medium is above the minimum fluidization velocity of the electrode, the intermittently-flowable electrode performs as a fluidized bed electrode or as a slurry electrode. When the flow of the fluidizing medium is below the minimum fluidization velocity, the intermittently-flowable electrode performs as a static packed bed electrode.

The inventors of the present invention have demonstrated a breakthrough in flowable electrodes systems, by achieving an intermittently flowable electrode which can flow into a cell electrode compartment in a variety of electrochemical systems, where it can self-assemble into an exceptionally conductive static electrode, and then can be converted back into a flowable fluidized state or a slurry state, on-demand. Such electrode combines the key advantages and functionalities of flowable electrodes with the low electric resistance of static electrodes, and is particularly beneficial for use in electrochemical systems, such as RFBs and CDI cells with flowable electrodes.

Crucially, it was found that by varying the operating modes of the intermittently-flowable electrode under specific conditions, the electrical conductivity of the electrode can be significantly increased, orders of magnitude higher than previously reported flowable electrodes systems. Electric conductivities of over 10,000 mS/cm were obtained for the intermittently-flowable electrode of the invention, being three orders of magnitude higher than characteristic conductivity of the state-of-art suspension electrodes used in electrochemical energy storage and water desalination systems. The unique properties of the intermittently-flowable electrode allowed overcoming the limitations of previously reported flow electrodes.

Thus, according to one aspect, the present invention provides an intermittently-flowable electrode comprising an electrode compartment comprising conductive particles and a liquid fluidizing medium in which said conductive particles are suspended, wherein the electrode has at least a first operating mode, in which the electrode is in a form of a flowable electrode and a second operating mode, in which the electrode is in a form of a self-assembled electrode, wherein the liquid fluidizing medium flows through the electrode compartment in both the first operating mode and the second operating mode.

The terms “operating mode” and “operating state” are used herein interchangeably.

According to some embodiments, in the first operating mode the electrode is in a form of a flowable electrode, wherein the suspended conductive particles are in a disassembled state. In further embodiments, in the first operating mode the electrode comprises conductive particles which flow through the electrode compartment together with the liquid fluidizing medium, in which they are suspended. In still further embodiments, the first operating mode, in which the electrode is in a form of a flowable electrode, comprises a fluidized bed electrode or a slurry electrode. Each possibility represents a separate embodiment of the invention.

In certain embodiments, the first operating mode comprises a fluidized bed electrode. The terms “fluidized bed electrode” and “flowable fluidized state” are used herein interchangeably and are meant to encompass a regular fluidized bed electrode, in which the conductive particles are contained within the electrode compartment; and an upflow fluidized bed electrode, which includes conductive particles, which can exit the electrode compartment and be disposed, for example, in a tube connected to the electrode compartment and/or in a storage tank being in fluid flow connection with the electrode compartment. In further embodiments, the fluidized bed electrode comprises conductive particles which flow through the electrode compartment is retarded relatively to the flow of the liquid fluidizing medium, in which they are suspended. In other words, in certain such embodiments, said conductive particles flow velocity is lower than the velocity of the fluidizing medium. In further such embodiments, the particle velocity is lower than the superficial velocity. In some embodiments, the difference in the velocity of the conductive particles and the superficial velocity ranges from about 1% to about 90%. The term “superficial velocity”, as used herein, refers to a flow rate of the pump connected to the intermittently-flowable electrode, divided by a cross-section area of the electrode compartment.

It is to be emphasized, that in the flowable fluidized state of the electrode, the conductive particles do not sediment in the electrode compartment under the combination of gravitational force and the fluidizing medium flow. In certain such embodiments, the angle between the direction of the flow of the fluidizing medium and the net gravitational force acting on the conductive particles is greater than 90° but smaller than 270°. In some embodiments, the angle between the direction of the flow of the fluidizing medium and the net gravitational force acting on the conductive particles is about 180°. In some embodiments the term “do not sediment”, refers to the relative velocity between the conductive particles and the fluidizing medium which is lower than the velocity of the fluidizing medium. The term “relative velocity”, as used herein, refers to the absolute value of the velocity of the liquid phase (e.g., fluidizing medium) minus the velocity of the solid phase alone (e.g., conductive particles).

In certain embodiments, the first operating mode comprises a slurry electrode. In further embodiments, the slurry electrode comprises conductive particles which flow through the electrode compartment together with the liquid fluidizing medium, in which they are suspended. In other words, in certain such embodiments, flow velocity of the conductive particles is essentially the same as the velocity of the fluidizing medium. In further such embodiments, the particle velocity is essentially the same as the superficial velocity. The term “essentially the same”, as used herein, refers in some embodiments to the difference in the velocity of the conductive particles and the superficial velocity of less than about 1%. In further embodiments, the term “essentially the same”, as used herein, refers to the relative velocity of at most about 0.1 mm/s.

It is to be emphasized, that in the slurry electrode, the conductive particles do not sediment in the electrode compartment under the combination of gravitational force and the fluidizing medium flow. In certain such embodiments, the angle between the direction of the flow of the fluidizing medium and the net gravitational force acting on the conductive particles is greater than 90° but smaller than 270°. In some embodiments, the angle between the direction of the flow of the fluidizing medium and the net gravitational force acting on the conductive particles is about 180°.

The flow rate of the fluidizing medium can be a typical rate for a slurry electrode or a fluidized electrode, as known in the art. In some embodiments, the flow rate of the fluidizing medium is defined as the superficial velocity. The flow rate of the fluidizing medium can be controlled by a pump. In some embodiments, the superficial velocity of the fluidizing medium ranges from about 10 μm/min to about 1000 mm/min. In further embodiments, the superficial velocity of the fluidizing medium ranges from about 100 mm/min to about 1000 mm/min. In yet further embodiments, the superficial velocity of the fluidizing medium ranges from about 100 mm/min to about 500 mm/min. In still further embodiments, the superficial velocity of the fluidizing medium ranges from about 200 mm/min to about 400 mm/min.

According to some currently preferred embodiments, the intermittently-flowable electrode is configured to transition between the first operating mode and the second operating mode in response to the change in the flow rate of the fluidizing medium. Accordingly, the flow rate of the fluidizing medium can be controlled in order to switch the electrode between its different operating modes or to maintain the electrode in one of the modes for a desired period of time.

According to some embodiments, in the second operating mode the electrode is in a form of a static electrode, wherein the suspended conductive particles are in a self-assembled state. In further embodiments, in the second operating mode the electrode is in a form of a packed bed electrode, also termed herein “static packed state”, in which the conductive particles self-assemble to form a static packed bed electrode, while the fluidizing medium flows through the electrode compartment. In some embodiments, when said intermittently-flowable electrode acts as a packed bed, the conductive particles sediment in the electrode compartment under the combination of gravitational force and the fluidizing medium flow. The term “conductive particles sediment”, as used herein, refers to the sedimentation of suspension material to fill at least about 10% (v/v), at least about 40% (v/v), or at least about 50% (v/v) of the electrode compartment volume. Each possibility represents a separate embodiment of the invention.

In some embodiments, the term “conductive particles sediment”, refers to the conductive particles having a flow velocity in the electrode compartment of about zero. In some embodiments, the liquid fluidizing medium flows through the electrode compartment in a non-horizontal direction. In certain such embodiments, the angle between the direction of the flow of the fluidizing medium and the direction of the sedimentation flow of the conductive particles is above about 90°, above about 100°, above about 110°, above about 120°, above about 130°, above about 140°, above about 150°, above about 160° or above about 170°. Each possibility represents a separate embodiment of the invention. In certain exemplary embodiments, the angle between the direction of the flow of the fluidizing medium and the direction of the sedimentation flow of the conductive particles is about 180°.

In some embodiments, the fluidizing medium is continuously circulated through the electrode compartment, during the first operating mode, in which the electrode is in a form selected from a fluidized bed electrode or a slurry electrode. In some embodiments, the fluidizing medium is continuously circulated through the electrode compartment, during the second operating mode, in which the electrode is in a form of a self-assembled electrode. In some embodiments, the fluidizing medium is continuously circulated through the electrode compartment, during the transition from the first operating mode to the second operating modes, and during the transition from the second operating mode to the first operating mode.

According to some embodiments, the transition between the first operating mode and the second operating mode is defined by the minimum fluidization velocity of the electrode. As used herein, the term “minimum fluidization velocity” refers to the threshold flow rate or velocity of the liquid fluidizing medium through the electrode compartment, in which the electrode transfers between modes of operation. In some embodiments, the minimum fluidization velocity is defined as the velocity where the structure of the electrode switches between static packed state to flowable state. In some other embodiments, the minimum fluidization velocity is defined as the velocity where the structure of the electrode switches between flowable state to static self-assembled state. According to some embodiments, the electrode of the present invention can transfer from the second operating mode to the first operating mode by increasing the flow velocity of the liquid fluidizing medium. According to some additional embodiments, the electrode of the present invention can transfer from the first operating mode to the second operating mode by decreasing the flow velocity of the liquid fluidizing medium.

The classical theoretic minimum fluidization velocity of the fluidizing medium in which the conductive particles are suspended is based on the Ergun equation and can be calculated by using Equation I:

$$( {ρ}_{p} - {ρ}_{w} ) g = \frac{150 μ ( 1 - {ɛ}_{0} ) {u}_{min}^{c l a s s i c}}{{ɛ}_{0}^{3} {d}^{2}} + \frac{1.75 {{ρ}_{w} ( {u}_{min}^{c l a s s i c} )}^{2}}{{ɛ}_{0}^{3} d} \qquad Equation I$$

Wherein uₘᵢₙ^{classic} is the classical theoretic minimum fluidization velocity neglecting the interparticle forces, ρₚ is the particle density, ρ_{w} is the liquid density, g is gravitational acceleration, μ is the fluidizing medium viscosity, d is the particle diameter, and ε₀ is the packed bed voidage.

Without wishing to being bound by theory or mechanism of action, it is assumed that the motion of the suspended conductive particles in the electrode compartments is affected by a variety of forces, including net gravitational, hydrodynamic drag and interparticle forces. Non-limiting examples of interparticle forces acting on the conductive particles within the electrode compartment are Van der Waals and electrostatic forces. It is further contemplated that for flow velocities of the fluidizing medium below the minimum fluidization velocity, net gravitational force overcomes hydrodynamic drag and the particles sediment into a packed bed structure with fluid flow between largely stationary particles. For flow velocities of the fluidizing medium above the minimum fluidization velocity, hydrodynamic drag overcomes gravitational force, and the particles flow through the fluidizing flow medium. According to some embodiments, the electrode is in the first operating mode when the flow of the fluidizing medium is above the minimum fluidization velocity, and in the second operating mode when the flow of the fluidizing medium is below the minimum fluidization velocity.

If the only forces acting on the conductive particles are hydrodynamic drag and net gravitational force, there is only one classical theoretic minimum fluidization velocity for the conductive particles. It has been surprisingly found by the inventors of the present invention that in contrast to previously reported flowable electrodes, significant cohesive forces can result in at least two actual minimum fluidization velocities for suspended conductive particles. Without wishing to being bound by theory or mechanism of action, it is contemplated that the difference between the two minimum fluidization velocities is caused by the presence of significant interparticle cohesive forces. The inventors of the present invention have unexpectedly found that the conductive particles can be interconnected by cohesive interparticle forces during the second operating mode, which is a packed bed state. When transforming the electrode from static self-assembled to flowable state, meaning from the second to the first operating mode, cohesive forces act to oppose drag forces and hold together the packed bed, resulting in a higher minimum fluidization velocity.

In some embodiments, the minimum fluidization velocity for the transition from the second operating mode to the first operating mode is different from the minimum fluidization velocity for the transition from first operating mode to the second operating mode. In some embodiments, the classical theoretic minimum fluidization velocity is lower compared to both the actual minimum fluidization velocity for the transition from the second operating mode to the first operating mode, and from the transition from the first operating mode to the second operating mode. According to additional embodiments, the minimum fluidization velocity for the transition from the second operating mode to the first operating mode is higher than for the transition from the first operating mode to the second operating mode. In certain such embodiments, the minimum fluidization velocity for transforming the structure of the electrode from static packed state to flowable state is higher than the minimum fluidization velocity for transforming the structure of the electrode from flowable state to static self-assembled state.

In certain embodiments, the minimum fluidization velocity for the transition from the second operating mode to the first operating mode is higher than for the transition from the first operating mode to the second operating mode is by least about 10%, by least about 20%, by at least about 50%, by at least about 70%, or by at least about 90%. In some related embodiments, the minimum fluidization velocity for the transition from the second operating mode to the first operating mode is higher than for the transition from the first operating mode to the second operating mode by at least about 100%, by at least about 200%, by at least about 300%, by at least about 500%, or by at least about 1000%. Each possibility represents a separate embodiment of the present invention.

According to some embodiments, the minimum fluidization velocity is above about 0.0001 mm/s for the transition from the second operating mode to the first operating mode, and for the transition from the first operating mode to the second operating mode. According to some embodiments, the minimum fluidization velocity for both transitions is in the range of about 0.0001 to about 1000 mm/s. According to further embodiments, the minimum fluidization velocity for both transitions is in the range of about 0.001 to about 1000 mm/s. According to yet further embodiments, the minimum fluidization velocity for both transitions is in the range of about 0.01 to about 1000 mm/s. According to still further embodiments, the minimum fluidization velocity for both transitions is in the range of about 0.1 to about 100 mm/s. According to some embodiments, the minimum fluidization velocity for both transitions is in the range of from about 0.1 to about 1 mm/s, or from about 1 to about 10 mm/s, or from about 10 to about 50 mm/s, or from about 50 to about 100 mm/s. Each possibility represents a separate embodiment of the invention. According to some exemplary embodiments, the minimum fluidization velocity for both transitions is in the range of about 1 to about 7 mm/s.

The actual minimum fluidization velocity for transferring from self-assembled to flowable state including cohesive forces can be predicted according to Equation II:

$$( {ρ}_{p} - {ρ}_{w} ) g = \frac{150 μ ( 1 - {ɛ}_{0} ) {u}_{min}^{p \to f}}{{ɛ}_{0}^{3} {d}^{2}} + \frac{175 {{ρ}_{w} ( {u}_{min}^{p \to f} )}^{2}}{{ɛ}_{0}^{3} d} - \frac{24}{π {ɛ}_{0} {d}^{3}} {F}_{p} \qquad Equation II$$

wherein uₘᵢₙ^{p→f} refers to the minimum fluidization velocity for the transition from the second operating mode to the first operating mode, or from self-assembled or packed state to flowable or fluidized state; Fₚ refers to the cohesive forces between two particles, such as but not limited to, London-van der Waals (VdW) force; ρₚ is the particle density; ρ_{w} is the liquid density; g is gravitational acceleration; μ is the fluidizing medium viscosity, d is the particle diameter, and ε₀ is the packed bed voidage.

Calculating the minimum fluidization velocity for the transition from the second operating mode to the first operating mode (uₘᵢₙ^{p→f}) from Equation II can be done in order to evaluate materials suitable for use as the conductive particles in the intermittently flowable electrodes. Without wishing to being bound by theory or mechanism of action, it is contemplated that if said velocity is much greater than the classical theoretic minimum fluidization velocity, then the pumping energy expended in re-fluidizing the electrode will be incredibly high in result, leading to energy consumption losses and complicated operating conditions. If the minimum fluidization velocity for the transition from the second operating mode to the first operating mode (uₘᵢₙ^{p→f}) is too small, meaning approximately equal to the classical theoretic minimum fluidization velocity, then the effect of cohesion forces will be weak, with the possible consequence of reduced electric conductivity in the packed bed state. Therefore, choice of suitable conductive particles according to Equation II allows fabrication of effective and advantageous intermittently-flowable electrodes.

As explained hereinabove, alternating the superficial velocity of the fluidizing medium allows control over the transition between the first and the second operating modes of the intermittently-flowable electrode. In some embodiments, the superficial velocity of the fluidizing medium ranges from about 0.1 mm/s to about 10 mm/s, in the first operating mode. In certain embodiments, the superficial velocity of the fluidizing medium ranges from about 1 mm/min to about 3 mm/s, about 3 mm/s to about 6 mm/s, or about 1 mm/s to about 5 mm/s in the first operating mode. In some embodiments, the superficial velocity of the fluidizing medium ranges from about 10 μm/s to about 5 mm/s in the second operating mode. In certain embodiments, the superficial velocity of the fluidizing medium ranges from about 100 μm/s to about 1 mm/s in the second operating mode.

Without wishing to being bound by theory or mechanism of action, it is contemplated that the properties of the conductive particles, such as, but not limited to, composition, size, shape, density, surface energy, surface roughness, concentration, or structure can be varied in order to control the minimum fluidization velocities of said particles, and the electrode performance. The parameters of the fluidizing medium, such as flow direction, flow rate or flow pressure, type, and the physical parameters of the electrode compartment, inter alia, electrode compartment thickness or volume, can also influence the minimum fluidization velocity of the conductive particles.

According to some embodiments, the conductive particles comprise a material selected from, but not limited to, metal, metal alloy, metal carbide, metal nitride, metal oxide, metal silicide, carbon, polymer, ceramics, and any combination thereof. Each possibility represents a separate embodiment of the invention. The type of the material can be selected according to the reaction taking place in the electrode compartment and/or in accordance with Equation II.

According to certain embodiments, the conductive particles comprise a metal or metal alloy. As used herein, the term “metal” is also meant to encompass metalloids. According to some exemplary embodiments, the conductive particles consist essentially of metal particles. Non-limiting examples of metals suitable for use in the electrode according to the principles of the present invention include Cu, Zn, Al, Si, Sc, Ti, V, Cr, Mn, Fe, Co, Ni, Ga, Ge, Y, Zr, Nb, Mo, Tc, Ru, Rh, Pd, Ag, Cd, In, Sn, Sb, Te, Hf, Ta, W, Re, Os, Ir, Pt, Au, Tl, Pb, Bi, Po and alloys and combinations thereof. Each possibility represents a separate embodiment of the invention. According to some exemplary embodiments, the metal is copper (Cu). According to additional exemplary embodiments, the metal is zinc (Zn).

According to some embodiments, the conductive particles comprise metal oxides, such as, but not limited to, LiCoO₂, LiFeO₂, LiMnO₂, LiMn₂O₄, Li₂MoO₄, LiNiO₂, sodium manganese oxide, copper hexancyanoferrate, nickel hexacyanoferrate, iron hexacyanoferrate, bismuth oxychloride, and combinations thereof. Each possibility represents a separate embodiment of the invention.

According to some embodiments, the conductive particles comprise polymers, such as, but not limited to, polyaniline or polyacetylene based conductive polymers or poly(3,4-ethylenedioxythiophene) (PEDOT), polypyrrole, polythiophene, poly(p-phenylene), poly(triphenylene), polyazulene, polyfluorene, polynaphtalene, polyanthracene, polyfuran, polycarbazole, tetrathiafulvalene-substituted polystyrene, ferrocence-substituted polyethylene, carbazole-substituted polyethylene, polyoxyphenazine, polyacenes, or poly(heteroacenes) and combinations thereof. Each possibility represents a separate embodiment of the invention.

According to certain embodiments, the conductive particles comprise carbon. Non-limiting examples of carbons suitable for use in the electrode according to the principles of the present invention include activated carbon, carbon black, graphitic carbon, carbon beads, carbon fibers, carbon microfibers, carbon nanotubes, carbon whiskers, fullerenic carbons, carbon nanotubes (CNTs), multi-walled carbon nanotubes (MWNTs), single-walled carbon nanotubes (SWNTs), graphene sheets or aggregates of graphene sheets, and materials comprising fullerenic fragments and any combination thereof. Each possibility represents a separate embodiment of the invention.

In some embodiments, the conductive particles have an activated surface. In some embodiments, the term “activated surface” refers to a metallic surface which is essentially free of native oxide. The surface of the conductive particles can be activated or functionalized through a variety of methods, such as, but not limited to, chemical activation methods, including, inter alia, acid treatment or addition of functional surface groups and physical activation methods, including, inter alia, plasma treatment and UV radiation. In some exemplary embodiments, the surface of the conductive particles is activated by acid treatment. In further embodiments, the acid treatment includes immersion of the conductive particles in an acid such as, but not limited to, HCl, HClO, HClO₂, HClO₃, HClO₄, HF, HBr, HI, H₂SO₄, HNO₃, H₃PO₄, acetic acid, derivatives of chloro-acetic acid, and combinations thereof. The concentration of the acid can range from about 0.0001 to about 5 M.

The structure of the conductive particles can be selected according to the desired functionality for use in the intermittently-flowable electrode of the present invention. For example, in supercapacitors or capacitive deionization systems, particles having high surface area or high porosity, such as, but not limited to activated carbon, are required in order to enable enhanced ion electrosorption. According to some embodiments, the conducive particles have a high surface area and/or high porosity.

The term “high surface area”, as used in some embodiments, refers to a surface area in the range from about 1 to about 3000 m²/g, such as, for example, 10-100 m²/g, 100-300 m²/g, 300-1500 m²/g or 1500-3000 m²/g. In further embodiments, the term refers to surface area of above about 50 m²/g, 75 m²/g, above about 100 m²/g, above about 125 m²/g, above about 150 m²/g, above about 175 m²/g, above about 200 m²/g, above about 225 m²/g, above about 250 m²/g, above about 275 m²/g, above about 300 m²/g, above about 350 m²/g, or above about 500 m²/g. In further embodiments, the term refers to surface area of above about 3000 m²/g. Each possibility represents a separate embodiment of the invention.

The term “high porosity”, as used herein, refers in some embodiments, to the porosity of the conductive particles' material of above about 50%. In further embodiments, the term refers to the porosity of above about 60%, 70%, or even 80%. Each possibility represents a separate embodiment of the invention. In some embodiments, the terms “high surface area” or “high porosity” includes materials having microparticles or nanoparticles.

In some embodiments, the conductive particles have a roughness ranging from about 10 nm to about 10 μm.

In electrochemical flow systems conductive particles can be used to allow intercalation, absorption or deposition of the redox species on the surface or in the bulk of the conductive particles. Said conductive particles can also be characterized by high surface area and/or high porosity or can have layered structure, such as, for example, of graphite. Core-shell particles are also encompassed within the scope of the present invention. The surface (or the shell) and the bulk (or the core) of the conductive particles can be made of different materials. The density of the surface material can be lower than the density of the bulk material. In certain embodiments the surface of the conductive particle comprises a conductive material and the bulk is made of an insulating material.

The conductive particles can comprise a combination of particles made of different materials. In further embodiments, the conductive particles comprise a combination of particles having different shapes, sizes, densities, bulk densities, surface energies, or any combination thereof. Each possibility represents a separate embodiment of the invention.

In some embodiments, the conductive particles are configured to adsorb, absorb, intercalate, catalyze redox reaction and/or induce deposition of an ion. Each possibility represents a separate embodiment of the invention.

In some embodiments, the conductive particles further comprise a redox species. The term “redox species”, as used herein, refers to a species, which takes part in an oxidation or reduction reaction in the electrochemical device.

In some embodiments, the redox species comprises a redox metal ion. The redox metal ion can be present on the surface or in the bulk of the conductive particle. The redox metal ion can be present in its reduced (i.e., metal form). In some embodiments, the metal ion is present in the pores of the conductive particle. The redox metal or metal ion can be deposited or adsorbed onto the conductive particles or absorbed or intercalated therein. Each possibility represents a separate embodiment of the invention. Non-limiting examples of suitable redox metal ions include zinc, iron, vanadium, chromium, lithium, sodium, magnesium, aluminum, nickel, calcium, lead ions and any combinations thereof. Each possibility represents a separate embodiment of the invention. According to some exemplary embodiments, the intermittently-flowable electrode comprises zinc deposited onto copper particles. In certain such embodiments, zinc acts as a redox species and copper as conductive particles of the electrode.

The redox metal ion can be present on the surface or in the bulk of the conductive particle in a form of a salt or a ceramic material. In some embodiments, the salt or ceramic material is deposited in the pores of the conductive particle. Each possibility represents a separate embodiment of the invention. The redox metal salt can be an inorganic or an organic salt.

The redox species can further include a hydrogen ion, a hydroxyl ion or a combination thereof. According to some embodiments, the conductive particles further comprise a hydrogen ion on the surface, in the bulk or in the pores thereof. Each possibility represents a separate embodiment of the invention. According to some embodiments, the conductive particles further comprise a hydroxyl ion on the surface, in the bulk or in the pores thereof. Each possibility represents a separate embodiment of the invention.

The mean particle size of the conductive particles can range from about 0.1 μm to about 5000 μm. According to some embodiments, the mean particle size of the conductive particles ranges from about 1 μm to about 1000 μm. According to further embodiments, the mean particle size of the conductive particles ranges from about 1 μm to about 500 μm. According to still further embodiments, the mean particle size of the conductive particles ranges from about 1 μm to about 100 μm. According to yet further embodiments, the mean particle size of the conductive particles ranges from about 1 μm to about 50 μm. According to still further embodiments, the mean particle size of the conductive particles ranges from about 10 μm to about 30 μm.

In additional embodiments, the mean particle size of the conductive particles ranges from about 0.1 μm to about 1 μm, from about 1 μm to about 10 μm, from about 10 μm to about 100 μm, from about 100 μm to about 200 μm, from about 200 μm to about 500 μm, from about 500 μm to about 1000 μm, or from about 1000 μm to about 5000 μm. In certain embodiments, the mean particle size of the conductive particles is at least about 0.1 μm, at least about 1 μm, or at least about 10 μm. In additional embodiments, the mean particle size of the conductive particles is at most about 500 μm, at most about 100 μm, or at most about 50 μm.

The term “particle size”, as used in various embodiments of the invention, refers to the length of the particle in the longest dimension thereof. According to some embodiments, the conductive particles have a shape selected from spherical, cubic, convex, cylindrical, triangular, various polygons, or any other complex geometrical shape. Each possibility represents a separate embodiment of the invention. According to some exemplary embodiments, the conductive particles have a spherical shape, and the term “particle size” refers to the particle's diameter. In some embodiments, the conductive particles have a cylindrical shape, such as CNTs, having a length selected from the range of about 0.1 to about 1000 μm, and a diameter selected from about 0.1 to about 1000 nm.

In some embodiments, the intermittently-flowable electrode comprises copper particles having a mean particle size ranging from about 1 to about 150 μm. In further embodiments, the intermittently-flowable electrode comprises copper particles having a mean particle size ranging from about 1 to about 50 μm. In yet further embodiments, the intermittently-flowable electrode comprises copper particles having a mean particle size ranging from about 5 to about 40 μm. In still further embodiments, the intermittently-flowable electrode comprises copper particles having a mean particle size ranging from about 10 to about 30 μm. In additional embodiments, the intermittently-flowable electrode comprises copper particles having a mean particle size ranging from about 50 to about 100 μm.

In some embodiments, the intermittently-flowable electrode comprises zinc particles having a mean particle size ranging from about 20 to about 200 μm. In further embodiments, the intermittently-flowable electrode comprises zinc particles having a mean particle size ranging from about 50 to about 150 μm.

In some embodiments, the conductive particles have an elongated shape, such as, for example, a nanowire (including nanowires), a whisker (including nano-whiskers), a strip (including nanostrips) or a tube (including nanotubes).

According to some embodiments, in the second operating mode, the conductive particles are present in the electrode compartment in a form of agglomerates. According to some embodiments, in the first operating mode, the conductive particles are present in the electrode compartment in a form of agglomerates. In some related embodiments, the conductive particles are present in the electrode compartment in a form of agglomerates in both the first operating mode and the second operating mode. The term “agglomerate”, as used herein, refers in some embodiments to an aggregation of two or more conductive particles. According to some embodiments, the agglomerate comprises at least five aggregated conductive particles. While conductive particles can be, for example, spherical or cubic (i.e., having an aspect ratio of about 1:1), agglomerates of said conductive particles can have an elongated shape (i.e., with an aspect ratio above 1:1). In some embodiments, the conductive particles or agglomerates thereof have an aspect ratio of larger than 1:1. In further embodiments, the aspect ratio of the conductive particles or agglomerates thereof is larger than about 2:1, about 5:1, about 10:1, about 20:1, or about 50:1. In still further embodiments, the aspect ratio of the conductive particles or agglomerates thereof is about 100:1.

In some embodiments, the conductive particles or agglomerates thereof have an aspect ratio ranging from about 1:1 to about 1000:1. In further embodiments, the aspect ratio of the conductive particles or agglomerates thereof ranges from about 2:1 to about 800:1, from about 5:1 to about 500:1, from about 10:1 to about 200:1, or from about 20:1 to about 100:1. In still further embodiments, the aspect ratio of the conductive particles or agglomerates thereof ranges from about 1:1 to about 10:1, from about 10:1 to about 100:1, or from about 100:1 to about 1000:1. In some exemplary embodiments, the aspect ratio of the conductive particles or agglomerates thereof ranges between about 2:1 to about 10:1.

The term “aspect ratio” as used herein, refers to the ratio between the length and the width of particles. Without wishing to being bound by theory or mechanism of action, it is contemplated that the high aspect ratio of the conductive particles improves charge percolation in the first operating mode (i.e., flowable state). For example, for a system of conductive spheres in a dielectric medium, the critical volume fraction at the onset of percolation is assumed to be roughly 60%, while for particles with aspect ratios approaching 100:1, the percolation threshold can be as low as 0.1% volume.

The term “particle size”, when used in connection with an agglomerate comprising two or more conductive particles, refers to the length of the agglomerate in the longest dimension thereof.

Conductive particles can be monodisperse or polydisperse. The term “mean particle size” can refer to the size of monodisperse particles or polydisperse particles. The term “mean particle size”, as used herein, refers in some embodiments, to an equivalent spherical diameter as determined by laser light diffraction scattering (or dynamic light scattering). In some embodiments, the term “mean particle size” refers to an arithmetic average of particle sizes as measured by conventional particle size measuring techniques well known to those skilled in the art, such as sedimentation field flow fractionation, photon correlation spectroscopy, or disk centrifugation. In other embodiments, said term refers to the arithmetical average of sizes of a certain portion of particles within said polydisperse particles, wherein said portion constitutes at least 10% of the total amount of polydisperse particles, at least about 20%, at least about 30%, at least about 40% or at least about 50% of the total amount of polydisperse particles. Each possibility represents a separate embodiment of the invention.

According to some embodiments, the conductive particles are interconnected by cohesive interparticle forces in the second operating mode.

The mean particle sizes of the conductive particles in the first operating mode and in the second operating mode may differ. For example, in the first operating mode the conductive particles can be in a form of particles, which are separated one from another by the fluidizing medium, while in the second operating mode said particles can be in a form of agglomerates, wherein there is direct contact between at least two particles within the agglomerate. In some embodiments, where the particles are separated, the volume fraction of the conductive particles within the electrode compartment ranges from about 5% to about 50%. In further embodiments, where the particles are separated, the volume fraction of the conductive particles within the electrode compartment ranges from about 5% to about 40%. In still further embodiments, where the particles are separated, the volume fraction of the conductive particles within the electrode compartment ranges from about 5% to about 30%. In some embodiments, where there is direct contact between the particles, the volume fraction of the conductive particles within the electrode compartment ranges from about 40% to about 80%. In further embodiments, where there is direct contact between the particles, the volume fraction of the conductive particles within the electrode compartment ranges from about 50% to about 75%. In still further embodiments, where there is direct contact between the particles, the volume fraction of the conductive particles within the electrode compartment ranges from about 60% to about 70%. Alternatively, the electrode can comprise agglomerates of the conductive particles in both the first and the second operating modes, while the size of the agglomerates in the two modes is different.

In some embodiments, the intermittently-flowable electrode comprises copper particles being in a form of agglomerates having an aspect ratio ranging from about 2:1 to about 10:1. According to further embodiments, the intermittently-flowable electrode comprises copper particles or agglomerates having mean particle size ranging from about 1 to about 50 μm in the first operating mode. According to still further embodiments, the intermittently-flowable electrode comprises copper particles or agglomerates having mean particle size ranging from about 50 to about 200 μm in the second operating mode.

The density of the conductive particles can range from about 1000 to about 22,500 kg/m³.

Provided herein below are some of the possible combinations of different conductive particles properties, which can be utilized to configure the intermittently-flowable electrode according to some embodiments of the present invention. In some embodiments, the conductive particles have densities in the range of about 6000 to about 9000 kg/m³, mean particle size in the range of about 10 μm to about 120 μm, and have minimum fluidization velocity in the range of above about 10 to about 100 mm/sec. In some exemplary embodiments, the conductive particles have densities in the range of about 6000 to about 7500 kg/m³, mean particle size in the range of about 10 μm to about 30 μm, and have minimum fluidization velocity is in the range of above about 0.1 to about 6 mm/sec.

According to some embodiments, the loading of the conductive particles in the electrode compartment is at least about 1% wt. According to further embodiments, the loading of the conductive particles in the electrode compartment is at least about 2% wt., at least about 3% wt., at least about 4% wt., or at least about 5% wt. Each possibility represents a separate embodiment of the invention.

The term “loading”, as used herein, refers to the proportion of the weight of the conductive particles in the total weight of the fluidizing medium and the conductive particles.

The inventors of the present invention have further unexpectedly found that the cohesive forces between the conductive particles enable exceptionally high electric conductivity in the packed bed state operating mode, which is orders of magnitude higher than previously reported flowable electrodes in electrochemical flow systems. Without wishing to be bound to any theory or mechanism, it is contemplated that the packed bed state allows electric charge to percolate within the conductive particles, and thus enabling exceptionally high electric conductivity within the electrode.

In some embodiments, the conductivity of the electrode in the second operating mode is at least one order of magnitude higher than the conductivity thereof in the first operating mode. In certain embodiments, the conductivity of the electrode is at least two orders of magnitude higher in the second operating mode compared to the conductivity of the electrode in first operating mode.

As used herein, the term “conductivity”, refers to electric conductivity, unless specified otherwise.

In some embodiments, the electrode has a conductivity of at least above about 0.01 mS/cm in the first operating mode. In further embodiments, the electrode has a conductivity ranging from about 0.01 to about 0.1 mS/cm, or from about 0.1 to about 1 mS/cm, or from about 1 to about 100 mS/cm, for the first operating mode. In additional embodiments, the electrode has a conductivity in the first operating mode which rangers from about 0.1 to about 10 mS/cm, or from about 0.5 to about 5 mS/cm, or from about 0.5 to about 2 mS/cm. In certain embodiments, the electrode has a conductivity lower than about 10 mS/cm in the first operating mode. In some exemplary embodiments, the electrode has a conductivity of at least about 0.1 mS/cm in the first operating mode.

In some embodiments, the electrode has a conductivity of at least about 10 mS/cm in the second operating mode, wherein the electrode acts as a packed bed electrode. In further embodiments, the electrode has a conductivity ranging from about 10 to about 100 mS/cm, or from about 100 to about 1000 mS/cm, or from about 1000 to about 100000 mS/cm, in the second operating mode. In additional embodiments, the electrode has a conductivity in the second operating mode ranging from about 100 to about 10000 mS/cm, or from about 500 to about 1500 mS/cm, or from about 1000 to about 2000 mS/cm. In some embodiments, the electrode has a conductivity of at least about 10000 mS/cm in the second operating mode. In some exemplary embodiments, the electrode has a conductivity of at least about 100 mS/cm in the second operating mode.

According to some embodiments, while the intermittently-flowable electrode is in the first operating mode, in which the electrode is in a flowable state, the conductive particles flow to or from the electrode compartment. According to additional embodiments, while said intermittently-flowable electrode is in the second operating mode, in which the electrode is in a form of a packed bed electrode, wherein the conductive particles sediment under the combination of gravitational force and the fluidizing medium flow in the electrode compartment, said electrode participates in a redox reaction or ion electrosorption as a static electrode. In some related embodiments, the conductive particles do not circulate outside of the electrode compartment in the second operating mode.

According to some embodiments, when the electrode is in the second operating mode, in which the electrode is in a form of a packed bed electrode, the conductive particles, which sediment under the combination of gravitational force and fluidizing medium flow are suspended in the fluidizing medium in the electrode compartment in an essentially uniform manner. According to further embodiments, the conductive particles, which sediment under the combination of gravitational force and fluidizing medium flow, are suspended in the fluidizing medium in the electrode compartment in an essentially uniform manner during the electrochemical operation of the device. In certain such embodiments, the angle between the direction of the flow of the fluidizing medium and the direction of the sedimentation flow of the conductive particles is about 180°. The term “electrochemical operation”, as used herein refers to the operation of the electrode under applied voltage and/or current.

The term “essentially uniform manner”, as used herein, denotes that the volume percentage of the conductive particles varies between two different portions of the electrode compartment by less than about 40%, less than about 20% or less than about 10%. The portion of the electrode compartment can refer to about 1/10 of the electrode compartment volume, 1/20 of the electrode compartment volume or 1/50 of the electrode compartment volume. Each possibility represents a separate embodiment of the invention.

According to some embodiments, the role of the fluidizing medium is to suspend the conductive particles. In some embodiments, the fluidizing medium suspends the conductive particles in the electrode compartment. The fluidizing medium can be any liquid that can suspend the conductive particles. Non-limiting examples of the fluidizing medium include water, a polar solvent, such as alcohols, or aprotic organic solvents.

In certain embodiments, the fluidizing medium includes a redox metal ion, a dissolved salt, acid, base, or brackish water. The fluidizing medium can be acidic, neutral or basic. Each possibility represents a separate embodiment of the invention.

In some embodiments, the fluidizing medium comprises water. The water can be brackish water. In further embodiments, the fluidizing medium comprises a feed solution.

In some embodiments, the fluidizing medium comprises an electrolyte. The electrolyte can be aqueous-based or organic-based. Each possibility represents a separate embodiment of the invention.

In certain embodiments, the electrolyte is acidic. Non-limiting examples of suitable acidic electrolytes include hydrochloric acid (HCl), sulfuric acid (H₂SO₄), trifluoromethanesulfonic acid, methanesulfonic acid, phosphoric acid (H₃PO₄), hydrobromic acid (HBr), and zinc bromide. In some embodiments, the concentration of the acidic electrolyte ranges from about 0.0001M to about 5M. In some exemplary embodiments, the concentration of the acidic electrolyte ranges from about 0.001M to about 1M.

Non-limiting examples of suitable organic solvents include ethylene carbonate (EC), propylene carbonate (PC), diethyl carbonate (DEC), dimethyl carbonate (DMC), ethyl formate (EF), methyl formate (MF), 1-ethyl-3-methylimidazolium bis (trifluoromethylsulfonyl)imide, 1-ethyl-3-methylimidazolium trifluoromethanesulfonate, 1-hexyl-3-methylimidazolium hexafluorophosphate, 1-ethyl-3-methylimidazolium dicyanamide, 11-methyl-3-octylimidazolium tetrafluoroborate and combinations thereof.

Without wishing to being bound by theory or mechanism of action, it is contemplated that ionic conductivity of the fluidizing medium can also influence the minimum fluidization velocity of the conductive particles. For example, the fluidizing medium can comprise an electrolyte, which ionic strength can be adjusted to obtain the desired value of minimum fluidization velocity for a particular electrochemical system or device. Ionic strength of the electrolyte can be varied, as known in the art, inter alia, by adding salts, which do not interact with the electrode's constituents or by diluting the electrolyte with an inert liquid.

In some embodiments, the ionic conductivity of the fluidizing medium ranges from about 0.01 mS/cm to about 100 mS/cm. In further embodiments, the ionic conductivity of the fluidizing medium ranges from about 0.1 mS/cm to about 10 mS/cm. In certain embodiments, the ionic conductivity of the fluidizing medium ranges from about 0.5 mS/cm to about 5 mS/cm.

According to certain embodiments, the intermittently-flowable electrode comprises copper particles having a mean particle size ranging from about 1 to about 50 μm in the first operating mode. In some related embodiments, the fluidizing medium comprises an electrolyte having an ionic conductivity ranging from about 0.1 mS/cm to about 200 mS/cm. In further embodiments, the fluidizing medium comprises an electrolyte having an ionic conductivity ranging from about 0.1 mS/cm to about 150 mS/cm. In still further embodiments, the fluidizing medium comprises an electrolyte having an ionic conductivity ranging from about 0.1 mS/cm to about 100 mS/cm. In yet further embodiments, the fluidizing medium comprises an electrolyte having an ionic conductivity ranging from about 0.1 mS/cm to about 50 mS/cm. In still further embodiments, the fluidizing medium comprises an electrolyte having an ionic conductivity ranging from about 0.1 mS/cm to about 10 mS/cm.

According to some embodiments, the electrode compartment is in a form of a flow channel being in fluid flow connection with at least one tube. Said flow channel can have any suitable shape, as known in the art, e.g., cylindrical shape. Alternatively, the flow-channel can have a square or rectangular cross-section. In some embodiments, said tube is connected directly to the electrode compartment, and enables the flow of the flowable electrode and/or the liquid fluidizing medium to the electrode compartment.

In some embodiments, the thickness of the electrode compartment ranges from about 0.5 mm to about 2000 mm. The term “thickness”, as used herein, refers in some embodiments to the distance between the inner walls on the electrode compartment, which are parallel to the direction of the flow of the fluidizing medium. In some embodiments, the height of the electrode compartment ranges from about 100 mm to about 5000 mm. The term “height”, as used herein, refers in some embodiments to the distance between the inner walls on the electrode compartment, which are perpendicular to the direction of the flow of the fluidizing medium.

The ratio of the height and the thickness of the electrode compartment can range from about 5:1 to about 1000:1. In some embodiments, the height of the electrode compartment ranges from about 0.25 mm to about 10000 mm. In certain embodiments, the height of the electrode compartment ranges from about 50 mm to about 250 mm.

Typically, the thicknesses of the electrode compartment and of the tube, which is in fluid flow connection with the electrode compartment are different. In some embodiments, the thickness of the tube is at least about 20% lower than the thickness of the electrode compartment. In further embodiments, the thickness of the tube is at least about 30% lower than the thickness of the electrode compartment, at least about 40%, at least about 50%, at least about 60%, at least about 70% or at least about 80% lower than the thickness of the electrode compartment.

In some embodiments, the electrode compartment is formed by at least one of a current collector and a separator. In further embodiments, the electrode compartment is formed between a current collector and a separator.

According to some embodiments, the intermittently-flowable electrode is connected to an external electric circuit. In further embodiments, the intermittently-flowable electrode is operationally connected to a current collector, which in turn is connected to the external electric circuit.

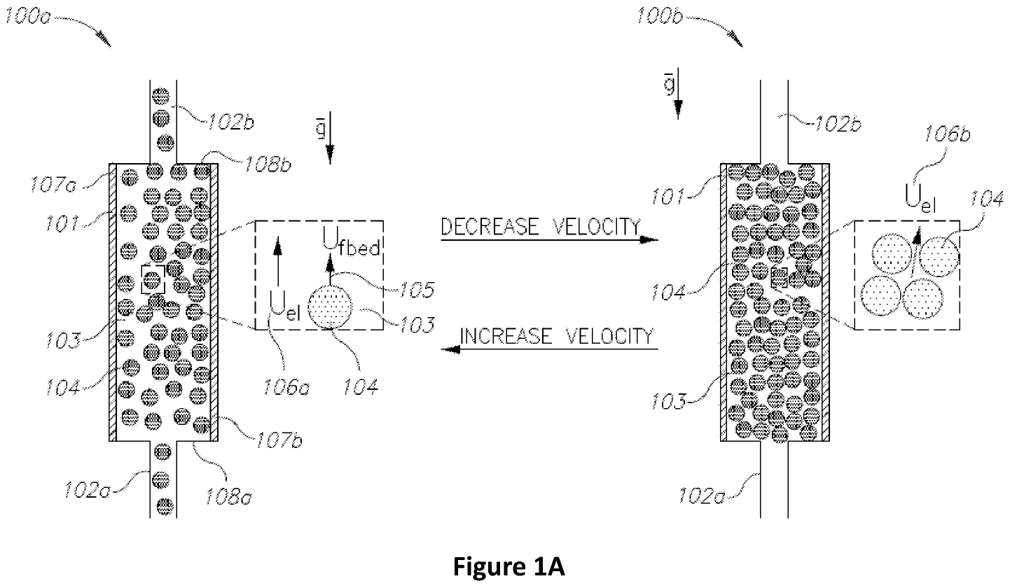

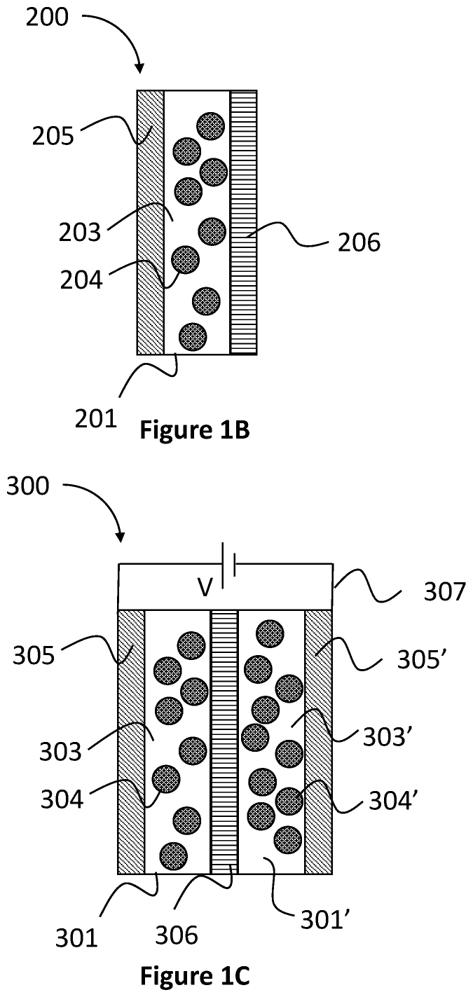

Reference is now made to FIG. 1A, which schematically illustrates the cross-sectional view of the intermittently-flowable electrode according to some embodiments of the present invention, wherein electrode 100a is in the first operating mode, in which the electrode is in a form of a fluidized bed electrode and electrode 100b is in the second operating mode, being in a form of a packed bed electrode. Electrode 100a includes electrode compartment 101 and liquid fluidizing medium 103 in which conductive particles 104 are suspended. Electrode 100a further includes tubes 102a and 102b which are in fluid-flow connection with electrode compartment 101. Fluidizing medium 103 and conductive particles 104 flow into electrode compartment 101 from tube 102a. Fluidizing medium 103 and conductive particles 104 flow from electrode compartment 101 into tube 102b. The angle between the direction of the flow of fluidizing medium 103 and the gravitational force (arrow g̅) is 180°. While in the first operating mode, conductive particles 104 flow to or from electrode compartment 101. On the right side of electrode 100a, there is provided a magnification of the electrode interior comprising fluidizing medium 103 in which conductive particles 104 are suspended. Velocity 106a (Uₑₗ) represents flow velocity of the liquid fluidizing medium wherein the fluidizing medium comprises an electrolyte. Velocity 105 (U_{fbed}) represents the flow velocity of the conductive particles. In the first operating mode, Velocity 106a is higher than Velocity 105, and both velocities 105 and 106a are higher compared to the minimum fluidization velocity required for the transition between the first operating mode and the second operating mode.

The thickness of the electrode compartment is defined as the distance between electrode compartment walls 107a and 107b, which are parallel to the flow of the fluidizing medium. The height of the electrode compartment is defined as the distance between electrode compartment walls 108a and 108b, which are perpendicular to the flow of the fluidizing medium.

Electrode 100b includes electrode compartment 101 and liquid fluidizing medium 103 in which conductive particles 104 are suspended. It can be seen that conductive particles 104 are closely packed in the second operating mode of the intermittently-flowable electrode. Electrode 100b further includes tube 102a and tube 102b, which are in fluid-flow connection with electrode compartment 101. Fluidizing medium 103 flows into electrode compartment 101 from tube 102a. Fluidizing medium 103 flows from electrode compartment 101 into tube 102b. While electrode 100b is in the second operating mode, in which the electrode is in a form of a packed bed electrode, the conductive particles sediment under the combination of gravitational forces (arrow g̅) and the fluidizing medium flow in the electrode compartment. The angle between the direction of the flow of the fluidizing medium 103 and the direction of the sedimentation flow of the conductive particles 104 is about 180°. On the right side of electrode 100b, there is provided a magnification of the electrode interior comprising fluidizing medium 103 in which closely-packed conductive particles 104 are suspended. Velocity 106b (Uₑₗ) represents flow velocity of the liquid fluidizing medium wherein the fluidizing medium comprises an electrolyte. When velocity 106b is lower than the minimum fluidization velocity, conductive particles 104 form a static electrode.

Transition from the first operating mode depicted by electrode 100a to the second operating mode depicted by 100b occurs when the flow rate (or velocity) of fluidizing medium 103 through electrode compartment 101 is decreased below the minimum fluidization velocity. Transition from the second operating mode depicted by electrode 100b to the first operating mode depicted by 100a occurs when the flow rate (or velocity) of fluidizing medium 103 through electrode compartment 101 is increased above the minimum fluidization velocity.

Reference is now made to FIG. 1B, which schematically illustrates the cross-sectional view of intermittently-flowable electrode 200 according to some embodiments of the present invention, wherein the electrode is in the first operating mode. Electrode 200 includes electrode compartment 201, which is formed between current collector 205 and separator 206. Electrode 200 further includes fluidizing medium 203 disposed within electrode compartment 201, in which conductive particles 204 are suspended.

According to another aspect of the present invention, there is provided an electrochemical device, comprising: a first current collector; a second current collector; at least one separator; and at least one intermittently-flowable electrode according to the principles of the present invention as described hereinabove, comprising at least one electrode compartment comprising conductive particles and a liquid fluidizing medium in which said conductive particles are suspended, the electrode compartment being positioned between said first or second current collectors and the separator; and at least one tube in fluid-flow connection with the electrode compartment. In some embodiments, the fluidizing medium is continuously circulated through the electrode compartment during the operation of the device.

The separator suitable for use in the electrochemical device according to the principles of the present invention can be any separator known in the art, such as, but not limited to, a membrane, spacer, gasket, or any combination thereof. Each possibility represents a separate embodiment of the invention.

In some embodiments, the membrane is an ion-permeable membrane. The ion-permeable membrane suitable for use in the electrochemical device according to the principles of the present invention can be any conventional membrane that is capable of ion transport. In some embodiments, the membrane is a liquid-impermeable membrane that permits the transport of ions therethrough, namely a solid or gel ionic conductor. In other embodiments, the membrane is a porous polymer membrane infused with a liquid electrolyte that allows for the shuttling of ions between the electrode compartment and the opposite solid electrode or between two electrode compartments, while preventing the transfer of electrons. In some embodiments, the membrane is a microporous membrane that prevents conductive particles from crossing the membrane. The ion-permeable membrane can be of any type suitable for use in the electrochemical devices according to the principles of the present invention, including, but not limited to, ion exchange membranes, including anion exchange membranes and cation exchange membranes; ion conducting membranes; proton exchange membranes (PEMs); proton conducting membranes (PCMs), and microporous separators. The membrane can be polymer-based, such as, for example, polyolefin, sulfonated tetrafluoroethylene-based fluoropolymer, sulfonated polysulfone, polyethyleneoxide (PEO) polymer; or ceramic material-based, such as, for example, zeolites. Non-limiting examples of suitable commercially available membranes include Neosepta® IEM and CMX, polyolefin Daramic®, Asahi SF-600, and Nafion®.

In some embodiments, the electrochemical device includes at least two electrode compartments, wherein the first at least one electrode compartment is positioned between the first current collector and the separator and the second at least one electrode compartment is positioned between the second current collector and the separator. In some embodiments, the current collector penetrates or pierces the electrode compartment using plates or needle-like connections. In additional embodiments, the device further comprises additional separators and tubes. In other embodiments, the electrochemical device includes at least one electrode compartments and at least one static solid electrode.

According to some embodiments, said electrochemical device comprises two intermittently-flowable electrodes according to the principles of the present invention. According to further embodiments, said electrochemical device comprises at least two electrode compartments, which are in fluid-flow connection with at least two tubes.

In some embodiments, the electrochemical device comprises two separators, including a first separator and a second separator. In certain such embodiments, the device includes two electrode compartments, wherein the first electrode compartment is positioned between the first current collector and the first separator and the second electrode compartment is positioned between the second current collector and the second separator. The first and the second separators can be separated from each other by a fluid medium.

In some embodiments, the electrochemical device comprises two ion-permeable membranes, including a first ion-permeable membrane and a second ion-permeable membrane. In certain such embodiments, the device includes two electrode compartments, wherein the first electrode compartment is positioned between the first current collector and the first ion permeable membrane and the second electrode compartment is positioned between the second current collector and the second ion permeable membrane. The first and the second ion-permeable membranes can be separated from each other by a fluid medium. In some embodiments, the first ion-permeable membrane is an anion exchange membrane and the second ion-permeable membrane is a cation exchange membrane.

According to some embodiments, the at least one electrode compartment functions as a positive electrode or as a negative electrode in the device. The chemical and physical characteristics of the conductive particles can thus be selected according to the desired chemical or physical reaction in the electrode compartment. In other embodiments, the electrochemical device includes at least one electrode compartments and at least one static solid electrode, wherein the solid electrode can be of any type suitable for use in an electrochemical device, including, but not limited to, conductive cloth, paper, mesh or felt. In some embodiments, the at least one electrode compartment is a positive electrode and a solid electrode is a negative electrode. In other embodiments, the at least one electrode compartment is a negative electrode and a solid electrode is a positive electrode.

In some embodiments, the electrochemical device includes a positive current collector and a negative current collector. The positive current collector is in contact with the positive electrode and/or the negative current collector is in contact with the negative electrode. In some embodiments, the positive current collector is in contact with the positive electrode compartment and/or the negative current collector is in contact with the negative electrode compartment. In some embodiments, the space between the current collector and the ion-permeable membrane forms the electrode compartment. In further embodiments, the current collector is in electric contact with the conductive particles and/or the fluidizing medium. The current collector can be electronically conductive and should be electrochemically inactive under the operation conditions of the electrochemical device. Non-liming examples of current collectors include graphite, copper, nickel, platinum, gold, aluminum, and titanium. The current collector can be in a form of plate, sheet or mesh, or any configuration for which the current collector may be distributed in the electrolyte and permit fluid flow. Selection of current collector materials is well-known to those skilled in the art.

According to some embodiments, said electrochemical device further comprises a shaker operationally coupled to the electrode compartment of the at least one intermittently-flowable electrode. According to further embodiments, the shaker is configured to provide mechanical vibration to the electrode compartment following operation of the intermittently-flowable electrode in the second operating mode.

In some embodiments, the electrochemical device according to the principles of the present invention is for use in energy storage. In some embodiments, the electrochemical device is for use in energy harvesting. In some embodiments, the electrochemical device is for use in water desalination.

Reference is now made to FIG. 1C, which schematically illustrates the cross-sectional view of electrochemical device 300 according to some embodiments of the present invention, comprising two intermittently-flowable electrodes is in the first operating mode. Electrochemical device 300 includes electrode compartments 301 and 301′, which are formed between current collector 305 and separator 306; and separator 306 and current collector 305′, respectively. Electrochemical device 300 further includes fluidizing medium 303 disposed within electrode compartment 301, in which conductive particles 304 are suspended and fluidizing medium 303′ disposed within electrode compartment 301′, in which conductive particles 304′ are suspended. Current collectors 305 and 305′ are connected to external electric circuit 307. Electrode compartments 301 and 301′ can be in fluid flow connection with respective tubes connecting them to storage tanks (not shown) containing fluidizing medium 303 and 303′, and optionally, conductive particles 304 and 304′, respectively. The storage tanks can further include at least one of an electrolyte, a feed solution, redox species, and water.

According to yet another aspect of the present invention, there is provided an energy storage and/or harvesting system comprising the electrochemical device according to the principles of the present invention as described hereinabove; and at least one external storage tank, which is in fluid flow connection with the at least one tube.

In some embodiments, the system comprises at least one tube comprising one or more tubes. In some embodiments, the at least one tube includes a tube, which connects the tank with the electrode compartment and delivers the conductive particles and/or the fluidizing medium from the tank to the electrode compartment and a tube, which connects the electrode compartment with the tank and delivers the conductive particles and/or the fluidizing medium from the electrode compartment to the tank. The term “tube” can refer to said two tubes as two parts of one tube.

In some embodiments, the system comprises at least one pump. In some embodiments, the pump is configured to induce the delivery of the conductive particles to the electrode compartment prior to the electrochemical operation of the system. In additional embodiments, the pump is configured to cycle the conductive particles and/or the fluidizing medium through the electrochemical device and/or the energy storage system. Cycling through the system can include cycling through the at least one tube, the at least one electrode compartment, at least one tank, or other components of the device. According to some embodiments, the pump is further configured to induce the delivery of the redox metal ion, hydrogen ion or hydroxyl ion.

Typically, energy storage and/or harvesting systems include membranes as separators. However, said storage systems can also be membraneless, such as for example, in laminar flow batteries. Said batteries can include a gasket as a separator. The gasket can have any form, which provides separation of the electrode compartments of the device, including, inter alia, creating a void between two electrode compartments. The gasket can be made of any suitable material, including, but not limited to, polymer, rubber or elastomer.

In some embodiments, said energy storage and/or harvesting system comprises at least two external storage tanks, which are in fluid flow connection with at least two tubes.

In some embodiments, the tank is configured to store the conductive particles prior to the electrochemical operation of the energy storage and/or harvesting system. In other embodiments, the tank is configured to store the fluidizing medium prior to the electrochemical operation of the system. In further embodiments, the tank is configured to deliver the conductive particles to the at least one tube and/or to receive the conductive particles from the at least one tube during the electrochemical operation of the system. In yet further embodiments, the tank is configured to deliver the fluidizing medium to the at least one tube and/or to receive the fluidizing medium from the at least one tube during the electrochemical operation of the system. According to some embodiments, the tank is further configured to store, deliver and/or receive the redox species. In certain embodiments, the storage tank is configured to store the conductive particles and/or the fluidizing medium and to deliver the conductive particles and/or the fluidizing medium to the at least one tube prior to the electrochemical operation of the system. In other embodiments, the tank is configured to store, deliver and/or receive the redox species from or to the energy storage and/or harvesting system during the electrochemical operation of the system. In certain embodiments, the fluidizing medium comprises an electrolyte.

In some embodiments, the contents of the tank are mixed before the electrochemical operation of the system. In some embodiments, the contents of the tank are continuously mixed during the electrochemical operation of the system.

The energy storage and/or harvesting system can include a plurality of tanks, such as, for example, two tanks. The different tanks can store different conductive particles, suitable for use in the positive electrode and in the negative electrode of the system. The different tanks can further store different redox species suitable for use in the positive electrode and in the negative electrode of the system.

The energy storage and/or harvesting system can further include additional tanks, which are not in a direct fluid flow contact with the at least one tube.

According to some embodiments, said energy storage and/or harvesting system comprises at least one static solid electrode and at least one intermittently-flowable electrode as described hereinabove. According to other embodiments, said energy storage and/or harvesting system comprise at least two intermittently-flowable electrodes.

In some embodiments, the fluidizing medium comprises an electrolyte. In such embodiments, the electrolyte is aqueous-based or organic-based.

In some embodiments, the energy storage and/or harvesting system is configured in a form selected from a redox flow battery, electrochemical flow supercapacitor or a capacitive mixing system. In such embodiments, the flow battery is selected from the group consisting of a zinc-bromine flow battery, hydrogen-bromine flow battery, quinone-bromine flow battery, vanadium-bromine flow battery, all quinone flow battery, all-iron flow battery, vanadium redox flow battery, lithium-ion flow battery, lithium-sulfur flow battery, sodium ion flow battery, sodium-sulfur flow battery, lead-acid flow battery, and nickel metal hydride flow battery.

In some embodiments, the energy storage system is configured in a form of a zinc-bromine flow battery. In further embodiments, the energy storage system is configured in a form of a zinc-bromine flow battery comprising at least one electrode compartment comprising zinc-based intermittently-flowable electrode as the anode. In certain embodiments, the zinc-based intermittently-flowable electrode comprises zinc deposited on copper particles. In further embodiments, the zinc-bromine flow battery comprises at least one traditional porous carbon or graphite electrode as the cathode. In some embodiments, the zinc-bromine flow battery further comprises a first storage tank comprising conductive particles and zinc ions solution and a second storage tank comprising conductive particles and bromine solution. The bromine solution can further include bromine sequestering agent (BSA).

According to another aspect, there is provided a water desalination system comprising the electrochemical device according to the principles of the present invention as described herein above. In some embodiments, the system further comprises a feed tank comprising a mixing vessel, being in fluid flow connection with the at least one tube and configured to mix the fluidizing medium with the conductive particles. In some embodiments, the fluidizing medium comprises a feed solution.

In some embodiments, the feed tank is configured to store the conductive particles prior to the electrochemical operation of the water desalination system. In other embodiments, the feed tank is configured to store the fluidizing medium prior to the electrochemical operation of the system. In further embodiments, the feed tank is configured to deliver the conductive particles to the at least one tube and/or to receive the conductive particles from the at least one tube during the electrochemical operation of the system. In yet further embodiments, the feed tank is configured to deliver the fluidizing medium to the at least one tube and/or to receive the fluidizing medium from the at least one tube during the electrochemical operation of the system. In certain embodiments, the feed tank is configured to store the conductive particles and/or the fluidizing medium and to deliver the conductive particles and/or the fluidizing medium to the at least one tube prior to the electrochemical operation of the system. In certain embodiments, the fluidizing medium comprises a feed solution and/or brackish water.

In some embodiments, the contents of the feed tank are mixed before the electrochemical operation of the water desalination system. In some embodiments, the contents of the feed tank are continuously mixed during the electrochemical operation of the system.

The water desalination system can include a plurality of tanks, such as, for example, three tanks. The different tanks can store feed solution, brackish water, deionized water, and/or brine.

The energy storage and/or harvesting system can further include additional tanks, which are not in a direct fluid flow contact with the at least one tube.

In some embodiments, the water desalination system comprises at least two intermittently-flowable electrodes, at least two electrode compartments, at least two tubes, and at least two separators.

According to some embodiments, in the electrode compartments, the conductive particles are charged during the electrochemical operation of the system and electrosorb salt ions. The conductive particles can be delivered to the mixing vessel following the electrochemical operation of the system for regeneration process. Regeneration process can be a spontaneous process, wherein the charged conductive particles spontaneously release salts via discharging collision. The water desalination system can further comprise two ion-permeable membranes and a brine tank and a product tank.

In some embodiments, the system comprises at least one tube. In some embodiments, the at least one tube includes a tube, which connects the tank with the electrode compartment and delivers the conductive particles and/or the fluidizing medium from the tank to the electrode compartment and a tube, which connects the electrode compartment with the tank and delivers the conductive particles and/or the fluidizing medium from the electrode compartment to the tank.

In some embodiments, the system comprises at least one pump. In some embodiments, the pump is configured to induce the delivery of the conductive particles to the electrode compartment prior to the electrochemical operation of the system. In additional embodiments, the pump is configured to cycle the conductive particles and/or the fluidizing medium through the electrochemical device. Cycling through the system can include cycling through the at least one tube, the at least one electrode compartment, at least one tank, or other components of the system.

The water desalination system can include any one of a membrane, a gasket, a salt bridge or a spacer. The spacer can include, inter alia, a planar slit or transport channel. In some embodiments, the spacer is made of a porous material. In certain embodiments, the separator is an ion-permeable membrane.

In other embodiments, the water desalination system is configured in a form of a Capacitive Deionization (CDI) system. CDI is an emerging technology commonly applied to brackish water desalination. For water desalination by CDI, the feedwater is typically treated using the phenomenon of electrosorption in porous carbon electrodes, which is a capacitive process (Porada, S. et al. Review on the Science and Technology of Water Desalination by Capacitive Deionization. Prog. Mater. Sci. 2013, 58 (8), 1388-1442). In some embodiments, the CDI comprises at least two intermittently-flowable electrodes, to be configured as the cathode and the anode. In some embodiments, the conductive particles assembling the flowable electrode in the CDI system comprise porous carbon particles. Said particles can be used to allow electrosorption of salt ions. The ions can be present on the surface and/or in the bulk of the carbon particles. Conductive particles of one electrode compartment comprise positive salt ions and conductive particles of the other electrode compartment comprise negative salt ions, based on the polarity of the electrochemical device.

The intermittently-flowable electrode according to the principles of the present invention can be used in additional applications, such as, but not limited to, electrowinning or capacitive mixing. Electrowinning is a process directed to scavenging metals from wastewater with metal ions. Capacitive mixing is an energy harvesting process which is based on mixing salty and less salty water streams.

According to yet another aspect, there is provided a method of operating the intermittently-flowable electrode or the electrochemical device comprising the intermittently-flowable electrode according to the various embodiments presented hereinabove, the method comprising:

flowing the liquid fluidizing medium through the electrode compartment;

increasing the flow velocity of the liquid fluidizing medium above the minimum fluidization velocity of the electrode, thereby inducing electrode operation in the first operating mode; and/or

reducing the flow velocity of the liquid fluidizing medium below the minimum fluidization velocity of the electrode, thereby inducing electrode operation in the second operating mode.

The steps of increasing the flow velocity and reducing the flow velocity can be performed repeatedly. In some embodiments, the step of increasing the flow velocity is performed prior to the step of reducing the flow velocity. In some embodiments, the step of reducing the flow velocity is performed prior to the step of increasing the flow velocity.

The step of increasing the flow velocity can be omitted if the step of flowing the liquid fluidizing medium through the electrode compartment is performed at a superficial velocity which is higher than the minimum fluidization velocity of the fluidizing medium. The step of reducing the flow velocity can be omitted if the step of flowing the liquid fluidizing medium through the electrode compartment is performed at a superficial velocity which is lower than the minimum fluidization velocity of the fluidizing medium.

According to some embodiments, the method comprises increasing the flow velocity of the liquid fluidizing medium above the minimum fluidization velocity of the electrode by at least about 1%. According to further embodiments, the method comprises increasing the flow velocity of the liquid fluidizing medium above the minimum fluidization velocity of the electrode by at least about 5%, at least about 10%, at least about 50%, or at least about 100%. In additional embodiments, the method comprises increasing the flow velocity of the liquid fluidizing medium above the minimum fluidization velocity of the electrode by at least about 200%, at least about 300%, or at least about 500%. Each possibility represents a separate embodiment of the invention.

According to some embodiments, the method comprises reducing the flow velocity of the liquid fluidizing medium below the minimum fluidization velocity of the electrode by at least about 1%. According to further embodiments, the method comprises reducing the flow velocity of the liquid fluidizing medium below the minimum fluidization velocity of the electrode by at least about 5%, at least about 10%, at least about 50%, or at least about 100%. In additional embodiments, the method comprises reducing the flow velocity of the liquid fluidizing medium below the minimum fluidization velocity of the electrode by at least about 200%, at least about 300%, or at least about 500%. Each possibility represents a separate embodiment of the invention.

According to some embodiments, the method further comprises applying electrical potential to the intermittently-flowable electrode. The electrical potential can be applied during each one of the method steps, including the step of flowing the fluidizing medium through the electrode compartment, the step of increasing the flow velocity of the fluidizing medium and the step of reducing the flow velocity of the fluidizing medium. According to some embodiments, the method further comprises providing electricity to the intermittently-flowable electrode. According to some embodiments, the method further comprises drawing electricity from the intermittently-flowable electrode. In certain embodiments, the method comprises charging the intermittently-flowable electrode. In certain embodiments, the method comprises discharging the intermittently-flowable electrode.

According to some embodiments, the method further comprises flowing the fluidizing medium through at least one tube. According to some embodiments, the method further comprises flowing the fluidizing medium through at least one tube which is in fluid flow connection with the electrode compartment.

The conductive nanoparticles and the fluidizing medium can be selected as disclosed hereinabove in connection with the electrode and device embodiments.

The flow velocity of the fluidizing medium can be increased above the minimum fluidization velocity of the electrode and/or reduced below the minimum fluidization velocity of the electrode by changing the superficial velocity of the fluidizing medium. The flow velocity (or the superficial velocity) of the fluidizing medium can be controlled, for example, by a pump. Superficial velocity can be changed gradually (e.g. linearly with time) or discretely between two predetermined values.

In some embodiments, the superficial velocity of the fluidizing medium ranges from about 10 μm/s to about 1000 mm/s. In further embodiments, the superficial velocity of the fluidizing medium ranges from about 100 mm/s to about 1000 mm/s. In some embodiments, the superficial velocity of the fluidizing medium ranges from about 0.1 mm/s to about 10 mm/s, when the electrode is in the first operating mode. In certain embodiments, the superficial velocity of the fluidizing medium ranges from about 1 mm/s to about 3 mm/s, about 3 mm/s to about 6 mm/s, or about 1 mm/s to about 5 mm/s when the electrode is in the first operating mode. In some embodiments, the superficial velocity of the fluidizing medium ranges from about 10 μm/s to about 5 mm/s when the electrode is in the second operating mode. In certain embodiments, the superficial velocity of the fluidizing medium ranges from about 100 μm/s to about 1 mm/s when the electrode is in the second operating mode.

According to some embodiments, the method further comprises controlling the ionic conductivity of the fluidizing medium. According some related embodiments, the method comprises adding a salt, which does not interact with the conductive particles, to the electrode compartment. According to additional related embodiments, the method comprises diluting the fluidizing medium with an inert liquid.

According to some embodiments, the method further comprises applying mechanical vibration to the electrode compartment of the intermittently-flowable electrode. According to some embodiments, the step of applying mechanical vibration is performed following electrode operation in the second operating mode. According to some embodiments, the method comprises applying mechanical vibration to the electrode compartment in both the first operating mode and the second operating mode. Mechanical vibration can be applied by any suitable device as known in the art, such as, but not limited to, a shaker, or by ambient vibrations. Ambient vibrations which come from any environmental source can be employed (e.g., if the intermittently-flowable electrode is integrated into a car, vibrations from the road can be harvested and used to apply mechanical vibration to the electrode compartment).

According to some embodiments, mechanical vibration is applied for a period of time ranging from about 5 seconds to about 10 minutes. According to further embodiments, mechanical vibration is applied for a period of time ranging from about 30 seconds to about 2 minutes. According to further embodiments, mechanical vibration is applied for about 1 minute.

According to some embodiments, mechanical vibration is applied at a frequency ranging from about 10 Hz to about 300 Hz. According to further embodiments, mechanical vibration is applied at a frequency ranging from about 30 seconds to about 100 Hz.

According to some embodiments, the method comprises forming a suspension of conductive particles in the liquid fluidizing medium prior to flowing the fluidizing medium through the electrode compartment. The loading of the conductive particles can be selected as disclosed hereinabove in connection with the electrode embodiments.

In some embodiments, the electrochemical device according to the principles of the present invention is for use in energy storage. In some embodiments, the electrochemical device is for use in energy harvesting. In some embodiments, the electrochemical device is for use in water desalination. In some related embodiments, the method further comprises flowing and/or storing the fluidizing medium in at least one tank. In additional related embodiments, the method further comprises flowing and/or storing the conductive particles in at least one tank.

As used herein, the term “about”, when referring to a measurable value such as an amount, a temporal duration, and the like, is meant to encompass variations of +/−20%, more preferably +/−5%, even more preferably +/−1%, and still more preferably +/−0.1% from the specified value, as such variations are appropriate to perform the disclosed methods.

As used herein and in the appended claims the singular forms “a”, “an,” and “the” include plural references unless the content clearly dictates otherwise. Thus, for example, reference to “an electrode” can include a plurality of such electrodes and equivalents thereof known to those skilled in the art, and so forth. It should be noted that the term “and” or the term “or” is generally employed in its sense including “and/or” unless the content clearly dictates otherwise.

The following examples are presented in order to more fully illustrate some embodiments of the invention. They should, in no way be construed, however, as limiting the broad scope of the invention. One skilled in the art can readily devise many variations and modifications of the principles disclosed herein without departing from the scope of the invention.

### EXAMPLES

### Example 1: Intermittently-Flowable Electrode Comprising Copper Particles—Construction, Operation and Characterization

The flowable electrode utilized copper metal particles having 99% purity (SIGMA-ALDRICH, MO, USA) and particle size of about 14-25 μm in diameter. Copper metal was chosen since it is relatively dense, and thus copper particles have a relatively high minimum fluidization velocity. Before the measurements began, the particles were placed in 400 ml of 0.1M HCl and mixed for one minute in order to remove any surface oxide layer. Subsequently, 1.5 L of deionized (DI) water were added to the suspension followed by filtering out the liquid phase using a vacuum pump and Whatman-93 filter paper. The treated copper particles were then added to DI water, in order to form a 5.5 vol % suspension which was used for the following experiment. The suspension was then placed into a tank and mixed at 400 rpm to ensure uniform particle concentration in the tank.

Electrode electronic conductivity measurements were held in a four-electrode configuration. The four-electrode cell was built in a polycarbonate tube with an inner diameter of 12.6 mm and length of 130 mm. In the tube, holes were drilled to insert four 1 mm diameter titanium wires to be used for four-electrode electrochemical impedance spectroscopy (EIS) measurements. The working and counter wire electrodes were 80 mm apart, and between them two sense wire electrodes were placed 10 mm apart. All wires were inserted roughly 1 mm into the tube and then sealed with epoxy to prevent leaks. The wires were connected to the leads of a Gamry 3000 potentiostat (Gamry, USA), and EIS measurements were taken when the electrode compartment was completely filled with the suspension and run continuously until a steady impedance was reached. The impedance was measured using a voltage amplitude of 5 mV and a frequency range between 1000 kHz and 100 Hz. The measured cell constant was 74 cm′. During the experiment, the suspension was pumped into a conductivity measurement cell via a 1.6 mm ID Norprene tube using a peristaltic pump (Master Flex, Gelsenkirchen, Germany).

Conductivity data was taken during several repeating velocity cycles; for the average cycle, the experiment began with an electrode superficial velocity of about 7 mm/s and then the velocity was lowered in several steps (downscan) with data collected at intervals of 0.3 mm/s, until it reached about 1.5 mm/s, for the first half cycle. Afterwards, the velocity was raised back to the initial value of about 7 mm/s in several steps (upscan), for the second half cycle.

Superficial velocity was calculated as the chosen pump flow rate divided by the measurement cell cross-sectional area. The flow velocity was changed by 0.3 mm/sec every 10 minutes followed immediately by mechanical vibration of the cell at 60 Hz for 60 seconds with 0.7 V amplitude (TMS—Smart shaker K2004E01, OH, USA). The vibrations were energetic enough to completely break apart any large-scale static structure (much larger than the particle size) formed in the conductivity cell.

EIS scans were executed every 1 minute to ensure a steady-state impedance was achieved, and only the results from the last recorded scan for each velocity step was used. Conversion to conductivity was made by dividing the measured cell constant by the measured resistance.

At the lowest flow velocities, the measured resistance reached extremely low values (down to about 10 mOhm). To mitigate interference due to the cable impedance, experiments were conducted using twisted pair cabling for both working and sense electrodes. To further eliminate such interference from the analysis, at velocities lower than 3 mm/sec, the frequency range for EIS was limited to 100 Hz-10 kHz.

Prior to the beginning of the velocity scan experiment, the liquid phase's ionic conductivity was measured to be 0.97 mS/cm (Metrohm, Herisau, Switzerland 856 conductivity module, 5-ring electrode 5 μS-20 mS). At the end of the experiment, the ionic conductivity of the liquid rose slightly to 0.994 mS/cm.

### Example 2: Conductivity of the Intermittently-Flowable Electrode Comprising Copper Particles in a Four-Electrode Measurement Cell

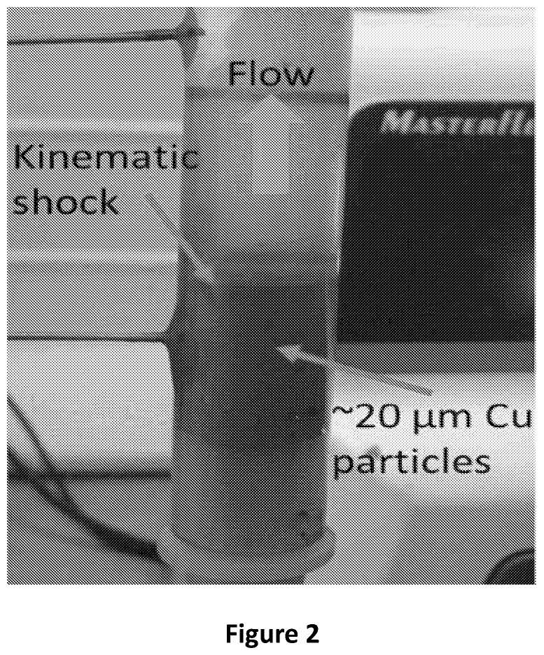

FIG. 2 demonstrates the rise of a fluidized bed consisting of copper metal particles in deionized (DI) water as it initially enters the four-electrode measurement cell from Example 1, at the high velocity. A clear kinematic shock was observed, as a characteristic of fluidized beds (Doornbusch, G. J. et al. Fluidized Bed Electrodes with High Carbon Loading for Water Desalination by Capacitive Deionization. J. Mater. Chem. A 2016, 4 (10), 3642-3647).

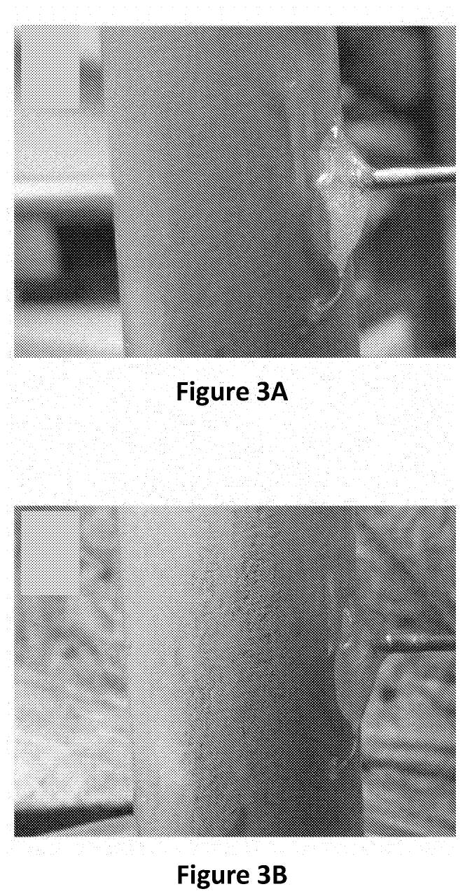

FIGS. 3A-3B show the electrode steady-state operation as either the flowable electrode (FIG. 3A) or the self-assembled electrode (FIG. 3B) depending on the electrode velocity.

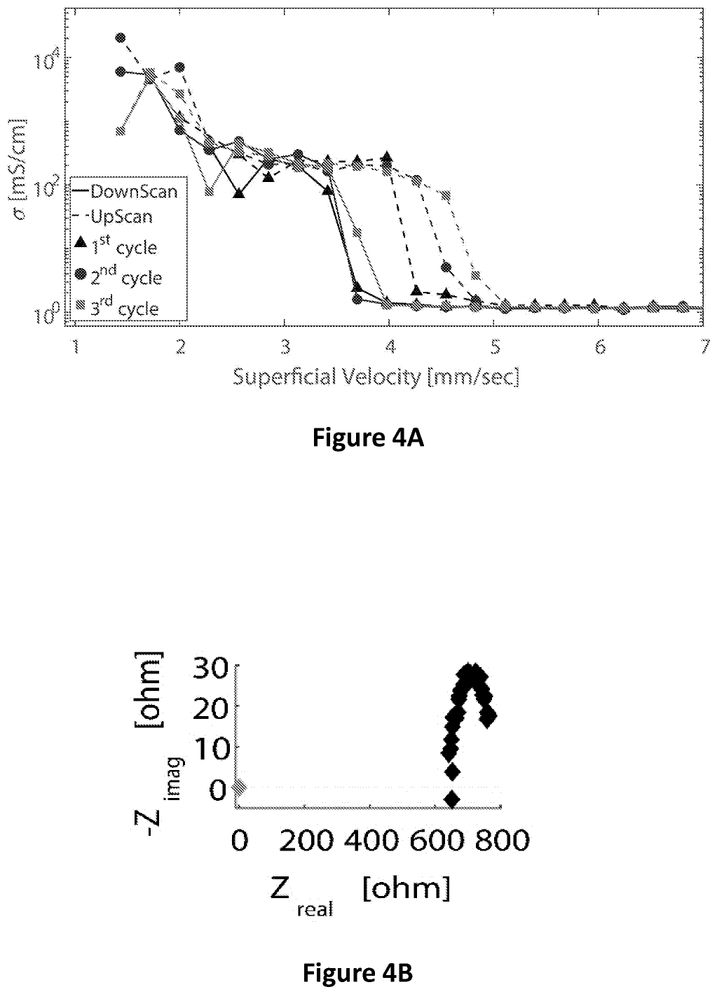

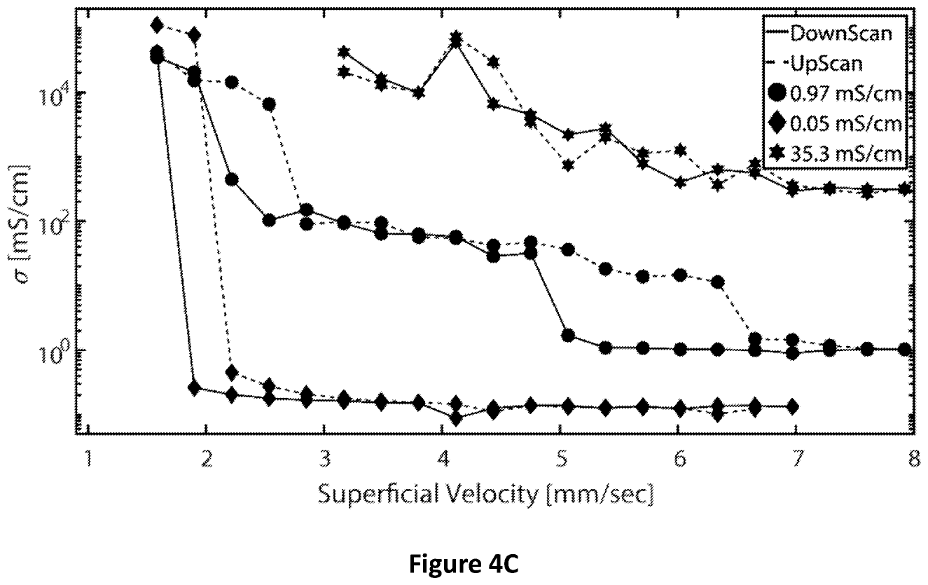

FIG. 4A demonstrates the influence of fluidizing medium velocity on the conductivity of the intermittently-flowable electrode, during three consecutive velocity cycles. At the high superficial velocities, near 7 mm/s, it was visually observed that the electrode seemed to be in the fluidized state and the copper particles were seen flowing, as the conductivity of the electrode was about 1 mS/cm.

As velocity was lowered (FIG. 4A, solid lines), the measured conductivity slightly increased until about 4 mm/s, where a sudden dramatic rise in the measured conductivity to about 100 mS/cm was observed. This jump coincided with the visual observation that the particles settled and formed a static structure with particles stationary while liquid was pumped through the cell. The observed minimum fluidization velocity, which is defined as the velocity where the structure switches between packed and fluidized states, was about 3.5-4 mm/s. As velocity was lowered further, the measured electrode conductivity continued to rise, reaching up to 10,000 mS/cm at the lowest velocity of 1.5 mm/s.

After measurements at the lowest velocity, the velocity was increased in intervals of 0.3 mm/s to in order to complete the cycle (FIG. 4A, dashed lines). The observed minimum fluidization velocity, which is defined as the velocity where the structure switches between self-assembled and flowable states, was significantly higher (compared to the downscan) and was closer to about 4.2-5 mm/s. The latter is a clear demonstration of a hysteresis in the minimum fluidization velocity of the system.

FIG. 4B shows the measured impedance of the electrode for all frequencies considered, both in the flowable state at 6.9 mm/s (right black diamonds) and in the static state at 1.5 mm/s (left gray diamond). The impedance of the electrode in the static state was largely consistent with a simple resistor circuit model, with approximately zero imaginary component at all frequencies (Zᵢₘ is about 0). By contrast, in the flowable state, a significant capacitive response was observed at lower frequencies.

In the static state, the overall conductivity which was measured (about 100-10,000 mS/cm) is several orders of magnitude above the liquid phase conductivity (about 1 mS/cm). Without wishing to being bound by theory or mechanism of action, in the static state the measured overall conductivity is approximately equal to the electric conductivity of the electrode, with negligible impact of ionic transport. By contrast, in the flowable state, the measured conductivity is near to that of the liquid phase conductivity (about 1 mS/cm), which indicates that the flowable structure formed either a poor percolation network with electric conductivity significantly less than 1 mS/cm or did not percolate electric charge. The dramatic, sudden jump in conductivity observed in FIG. 4A during the transition between states may be attributed to the attainment of a percolation threshold, which may suggest that the flowable structure did not percolate electric charge.

FIGS. 4A and 4B, coupled with the visual observations of a transition between flowable and static electrode (FIGS. 3a and 3b) demonstrate the concept of the intermittently-flowable electrode, which can either be flowable or self-assemble into a highly conductive structure depending on the superficial velocity chosen.

FIG. 4C shows measurements of conductivity during velocity cycling for varying electrolyte ionic strength. When the ionic conductivity of the liquid phase of the electrode was reduced from about 1 mS/cm to 0.05 mS/cm via dilutions with DI water, the measured conductivity in the flowable state was reduced to about 0.1 mS/cm. The velocity at which a jump in conductivity is observed is significantly reduced (to about 2 mm/s), and there is only a single measured jump from about 0.1 mS/cm to over 104 mS/cm with reduced hysteresis. Visual observations from the diluted system showed only a clear transition from packed structure to uniform flowable state at around 2 mm/s, without an observable intermediate, inhomogeneous flowable state. Increasing the ionic conductivity of the liquid phase to 35.3 mS/cm by adding NaCl salt results in about 300 mS/cm measured conductivity in the flowable state. A sharp transition between low and high conductivity was not measured and instead, a continuous rise in conductivity can be seen until reaching the packed bed state at which conductivity once again reached well over 104 mS/cm.

The observations in FIGS. 4A and 4C demonstrate that the observed switchability and electrode performance is dictated by various forces acting on the particles. When in the flowable state, the electrode can be classified as an upflow fluidized bed. In the classical descriptions of fluidized beds, the particle's gravitational force balances fluidic drag and buoyancy force. Further, the transition between packed and fluidized states occurs at a minimum fluidization velocity, which was calculated to be 0.02 mm/s for the 20 μm copper particles employed in this intermittently-flowable electrode. From FIG. 4A, the measured transition velocity between static and flowable states during the downscan is about 2.5 mm/s, which is two orders of magnitude higher than the calculated minimum fluidization velocity. The hysteresis in FIGS. 4A and 4C demonstrates that the minimum fluidization velocity for the transfer from fluidized state to packed state is lower compared to the transfer from packed state to fluidized state. The observed hysteresis is not predicted by classical fluidized bed theory, which only predicts one value of the minimum fluidization velocity. Without wishing to being bound by theory or mechanism of action, it is hypothesized that the forces acting on the copper particles are not simply hydrodynamic drag and gravitational and that the high observed minimum fluidization velocity, and the observed hysteresis are due to the role of interparticle cohesive forces, notably Van der Waals attractive forces. The cohesive forces holding particles in intimate contact may be the cause of the exceptionally high conductivity observed in lower velocities. Van der Waals attraction forces promote particle agglomeration, which can result in a larger effective particle size, and a higher minimum fluidization velocity.

### Example 3: Particle Size Distribution of the Intermittently-Flowable Electrode Comprising Copper Particles

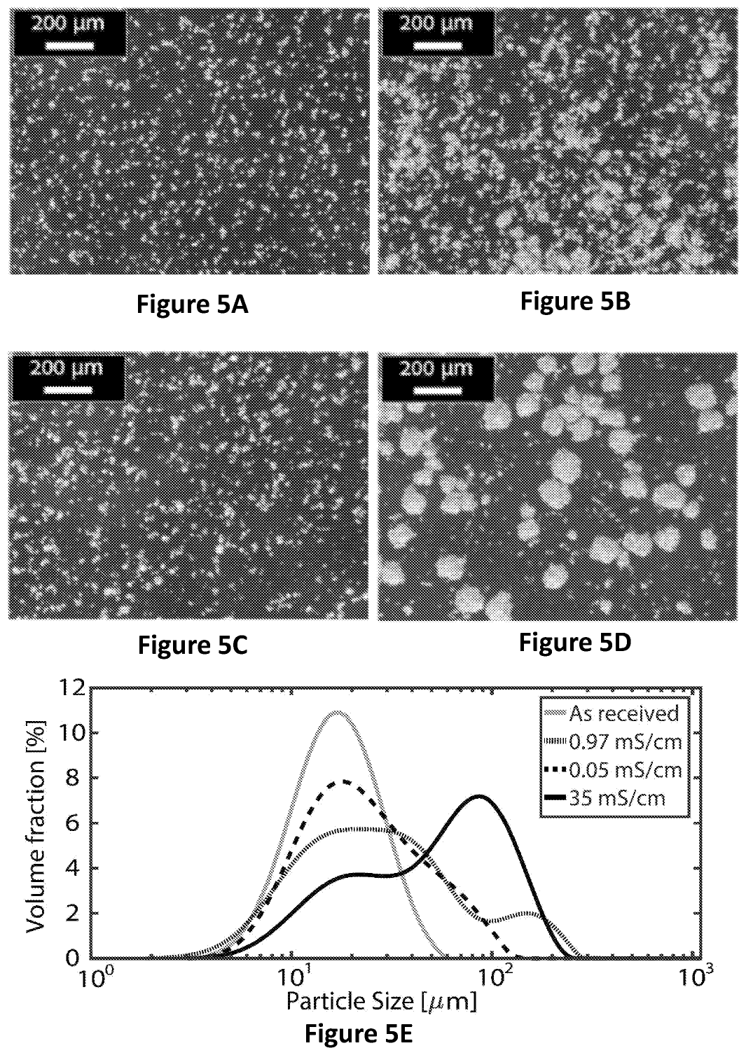

FIGS. 5A-5D represent white light images (Leica DMS1000, Wetzlar, Germany, 300× magnification) of the as-received copper particles suspended in DI water (FIG. 5A), and of the flowable electrode after the experiments described in Example 2, which results are presented in FIG. 4A (FIG. 5B). As can be seen in FIG. 5A, the particles are roughly the nominal size of 20 μm but in FIG. 5B there are numerous large agglomerates with sizes of order 100 μm, indicating significant interparticle attraction in the electrode compartment. Without wishing to being bound by theory or mechanism of action, the effect of ionic strength on the particles' behavior and transition velocity can be explained via the interplay of Van der Waals attractive and electrostatic repulsive forces acting on articles. Such interplay is captured by the Derjaguin-Landau-Verwey-Overbeek (DLVO) theory, wherein repulsive forces increase at decreasing ionic strength due to electric double layer expansion and decrease at increasing ionic strength due to electric double layer contraction (Y. N. Hilal, P Langston, V Starov Adv Colloid Interf. Sci., 134-135 (2007), pp. 151-166) As can be seen in FIG. 5C, when the electrode ionic conductivity was decreased to 0.05 mS/cm, the average size of the particle agglomerate has also decreased, consistent with relatively larger electrostatic repulsion forces between particles. Increasing salt concentration and conductivity to 35 mS/cm resulted in substantially larger agglomerates (FIG. 5D).

A quantitative particle size distribution measurement of the samples pictured in FIGS. 5A-5D was performed via a laser diffraction particle size analyzer (Malvern Mastersizer 2000, Worcestershire, UK) and presented in FIG. 5E. The results presented in FIGS. 4C and 5C-5D demonstrate that the transition velocity between flowable and static states can be tuned via the interplay between attractive and repulsive interparticle forces (e.g., by varying ionic conductivity of the fluidizing medium).

### Example 4: Conductivity of Intermittently-Flowable Electrode Comprising Zinc Particles in a Four-Electrode Measurement Cell

The flowable electrode was composed of zinc particles having a mean particle size of about 90-100 μm that were pretreated with hydrochloric acid. The particles were suspended in deionized water to obtain a 5.4% volume solution. The 5.4 vol % zinc suspension was pumped from the mixing tank into an electrode compartment via a 25 cm long, 1.6 mm inner diameter (ID) Norprene tube using a peristaltic pump (Master Flex, Gelsenkirchen, Germany) at different flow velocities. The tube was connected to the electrode compartment using a polyethylene (PE) funnel with a 9 mm inlet ID and a 12 mm outlet ID (Burkle, Bad Bellingen, Germany) and PE connectors to provide a uniform flow to the electrode compartment. The electrode compartment was in the form of a four-electrode conductivity measurement cell composed of a 13 mm ID and 130 mm length polycarbonate tube. Four titanium wires, 1 mm diameter, were used as the electrodes. The wires were inserted 1 mm into the electrode compartment on the same side of the tube through drilled holes and sealed with epoxy to prevent leaks. The distance between the working and counter electrodes was 8 cm, the distance between the two sense electrodes was 1 cm, cell design was based on the cells used by Petek et al. and Cohen et al. After reaching the top of the cell, the suspension left the conductivity measurement system into another 9-12 mm funnel connected to a 60 cm 3 mm ID PTFE tube (Bola, Grunsfeld, Germany) from which it flowed back to the mixing tank.

For the velocity cycles, the velocity was reduced from high superficial velocity by intervals of 0.3 mm/s, with a dwell time of 10 min at each velocity. When reaching the lowest velocity allowed in the experiment, a velocity upscan was initiated with the same velocity intervals and dwell times to complete the full cycle. Superficial velocity was calculated as the pump flow-rate divided by the measurement cell cross-sectional area. Upon switching velocity, a mechanical vibration of the cell was immediately performed at 60 Hz for 60 seconds with 0.7 V amplitude (TMS—Smart shaker K2004E01, OH, USA). The vibrations were energetic enough to completely break apart any large-scale static structure observable by eye which had formed in the electrode compartment. The highest and lowest velocities in the cycle varied depending on the material and experimental conditions used. The highest velocity value was chosen when electrode conductivity showed no further dependence on increasing flow velocity, which usually coincided with when the overall electrode conductivity roughly equaled the ionic phase conductivity. The low velocity limit was chosen as the lowest velocity than avoided clogging of the flow system during the experiment, and was generally lower than the point when the electrode became visibly static. The experimental velocity cycling and mechanical shaking were automated using a custom-developed LabVIEW code, and by connecting the needed instruments (pump, shaker) to a DAQ 6001 (National Instruments, TX, USA). Conductivity measurements were executed every 1 minute and recorded using the Gamry sequence wizard. A potentiostat was hooked to cell using a four-electrode setup to eliminate external noise and resistance measurement were taken and converted to conductance.

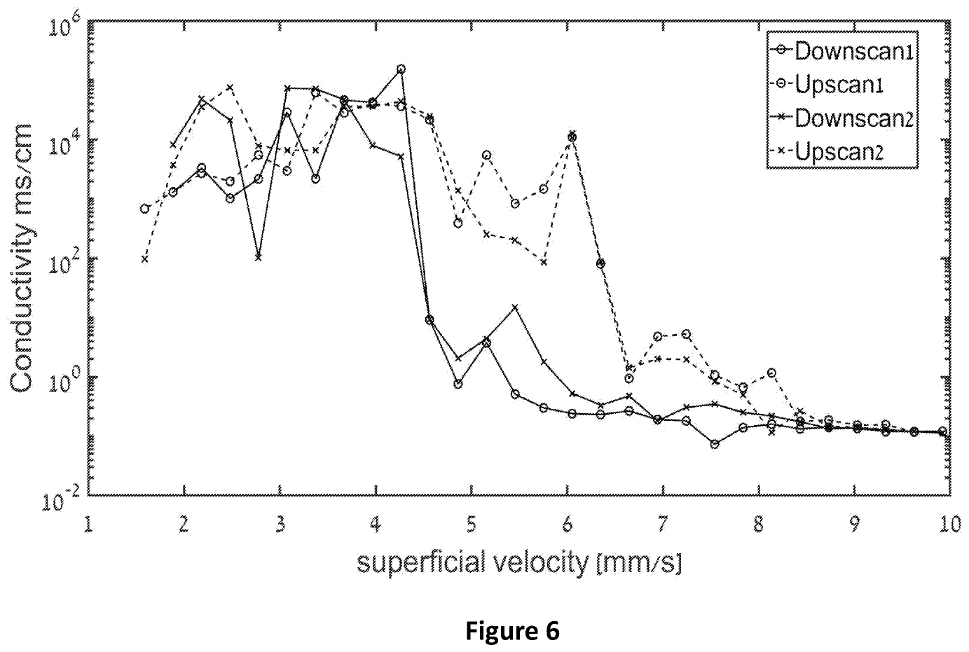

FIG. 6 demonstrates the influence of fluidizing medium velocity on the conductivity of the intermittently-flowable electrode comprising zinc particles, during two consecutive velocity cycles. As in the case of the intermittently-flowable electrode comprising copper particles, as velocity was lowered, the measured conductivity slightly increased followed by a dramatic rise in the measured conductivity to about 10,000 mS/cm was observed.

The observed minimum fluidization velocity again was significantly higher for the upscan compared to the downscan, demonstrating a hysteresis in the minimum fluidization velocity of the system.

### Example 5: Zinc-Bromine Flow Battery Comprising Intermittently-Flowable Electrode

Following materials were used in the zinc-bromine flow cell experiment: Zinc Bromide 98%, Alfa Aesar, Zinc Chloride for analysis, Alfa Aesar, Bromine for analysis, Merck, Hydrochloric acid 2M, Fluka, Ultrapure deionized water, 18.2 MΩ*cm, Copper powder, spherical, −170+270 mesh, 99.9%, Alfa Aesar, fraction <75 μm, isomolded graphite for current collectors (Graphitestore).

The battery cell included: a bromine compartment with a volume of 50 cm³; a cathode made of perforated isomolded graphite parallel and adjacent to the membrane; Nafion 117 membrane (FuelCellStore) having dimensions 6.5×1.5 and geometric area of 9.75 cm²; and a zinc electrode compartment. The zinc electrode compartment had the following dimensions: 7.5 cm×1.5 cm×0.4 cm and a volume of 4.5 cm³. The cross-sectional area of the zinc electrode compartment was 1.5 cm×0.4 cm, which equals to 0.6 cm². A current collector was made of a pair of isomolded graphite bars disposed on the long edges of the zinc compartment, facing each other, normal to the membrane plane, having a contact area: 7.5 cm×0.4 cm×2, which equals to 6 cm².

20 g of copper powder were etched with 0.4 M HCl for 3 min to remove the surface oxide layer, washed with DI water, vacuum-filtered and dispersed in 100 mL ZnCl₂ 1 M in a magnetically stirred tank to achieve a 2.2 vol % fraction. The dispersion was circulated through the stirred tank and the zinc electrode compartment of the battery cell at 3.9 cm³/s (6.5 mm/s) using the Cole Palmer Masterflex L/S peristaltic pump with L/S 14 Masterflex tubing. The bromine compartment was filled with 50 mL of 1M ZnBr₂+0.2 M Br₂ solution. The battery cell was continuously shaken with the Vortex Genie 2 (Scientific Industries) to prevent particles' agglomeration.

100% state-of-charge (SOC) was defined as conversion of all the bromide in the bromine compartment into tribromide, i.e. 5720 C of charge. The battery cycle was performed with the potentiostat (VSP, Biologic Science Instruments) at 100 mA.

Zinc Bromine Flow Battery Charge-Discharge Experiment with the Intermittently-Flowable Electrode being in the First Operating Mode (i.e., in a Form of Flowable Electrode).

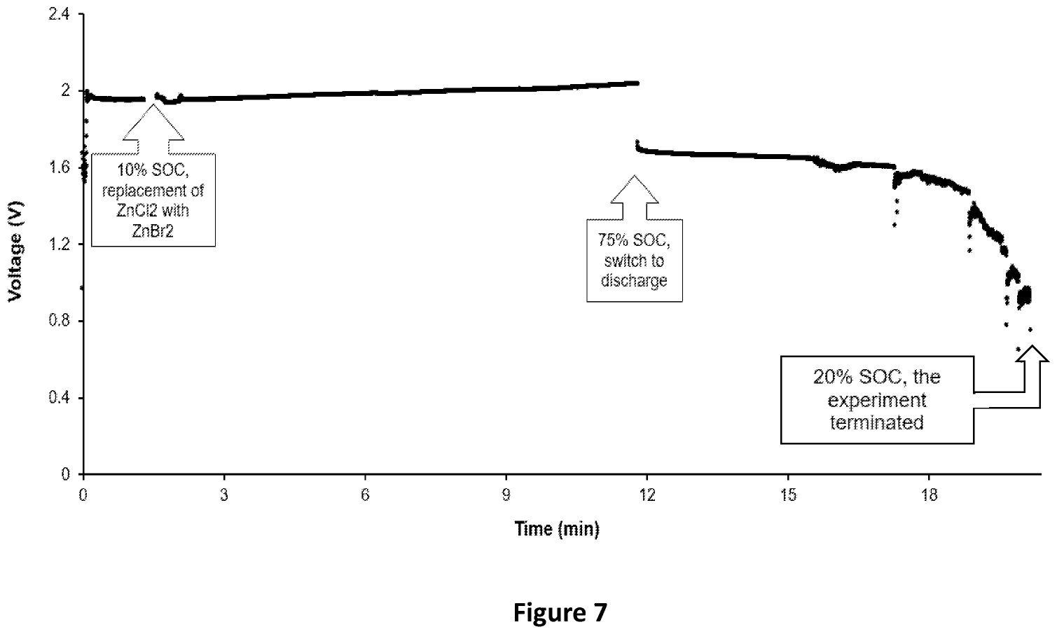

In this trial, the flow battery was first charged to 10% SOC to coat the copper particles with zinc, then 80 mL of ZnCl₂ 1 M solution was removed and replaced with 80 mL ZnBr₂ 1 M solution. The charging was continued up to 75% SOC and then followed by the discharge. The discharge was terminated at 20% SOC due to the appearance of bare copper particles (FIG. 7). The intermittently-flowable electrode was in the first operating mode (i.e., in a form of a flowable electrode) during both charging and discharging steps. The zinc-bromine flow battery performance with the intermittently-flowable electrode discharged up to 20% SOC was characterized by coulombic efficiency of 73%, energy efficiency of 57%, and voltage efficiency of 78%.

Zinc Bromine Flow Battery Charge-Discharge Experiment with the Intermittently-Flowable Electrode Switching Between the First and the Second Operating Modes.

In one trial, the flow battery is first charged to 10% SOC to coat the copper particles with zinc, then 80 mL of ZnCl₂ 1 M solution is removed and replaced with 80 mL ZnBr₂ 1 M solution. The charging is continued up to 75% SOC. The zinc electrode is in the first operating mode (i.e., flowable electrode) during the charging step. The velocity of the dispersion circulation through the zinc electrode compartment is reduced to switch the electrode to the second operating mode (i.e., self-assembled electrode). The flow battery is then discharged to a predetermined SOC.

In another trial, the flow battery is first charged to 10% SOC to coat the copper particles with zinc, then 80 mL of ZnCl₂ 1 M solution is removed and replaced with 80 mL ZnBr₂ 1 M solution. The charging is continued up to 75% SOC. The zinc electrode is in the second operating mode (i.e., self-assembled electrode) during the charging step. The velocity of the dispersion circulation through the zinc electrode compartment is increased to switch the electrode to the first operating mode (i.e., flowable electrode). The flow battery is then discharged to a predetermined SOC.

The foregoing description of the specific embodiments will so fully reveal the general nature of the invention that others can, by applying current knowledge, readily modify and/or adapt for various applications such specific embodiments without undue experimentation and without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. The means, materials, and steps for carrying out various disclosed functions may take a variety of alternative forms without departing from the invention.

1. An intermittently-flowable electrode comprising an electrode compartment comprising conductive particles and a liquid fluidizing medium in which said conductive particles are suspended, wherein the electrode has at least a first operating mode, in which the electrode is in a form of a flowable electrode and a second operating mode, in which the electrode is in a form of a self-assembled electrode, wherein the liquid fluidizing medium flows through the electrode compartment in both the first operating mode and the second operating mode.

2. (canceled)

3. The electrode according to claim 1, wherein the flowable electrode is selected from a fluidized bed electrode and a slurry electrode.

4. (canceled)

5. The electrode according to claim 1, wherein the electrode is configured to transition between the first operating mode and the second operating mode in response to the change in the flow rate of the fluidizing medium.

6. The electrode according to claim 1, wherein a transition between the first operating mode and the second operating mode is defined by a minimum fluidization velocity of the electrode, wherein the minimum fluidization velocity for the transition from the second operating mode to the first operating mode is higher than for the transition from the first operating mode to the second operating mode by least about 10%, and wherein the conductive particles are interconnected by cohesive interparticle forces in the second operating mode.

7. (canceled)

8. (canceled)

9. The electrode according to claim 6, wherein the minimum fluidization velocity for both transitions is above about 1 μm/s.

10. The electrode according to claim 1, wherein the liquid fluidization medium flows through the electrode compartment in a non-horizontal direction.

11. The electrode according to claim 1, wherein the conductive particles comprise a material selected from the group consisting of metal, metal alloy, metal carbide, metal nitride, metal oxide, metal silicide, carbon, polymer, ceramics, and any combination thereof.

12. (canceled)

13. The electrode according to claim 11, wherein the metal is selected from the group consisting of Cu, Zn, Al, Si, Sc, Ti, V, Cr, Mn, Fe, Co, Ni, Ga, Ge, Y, Zr, Nb, Mo, Tc, Ru, Rh, Pd, Ag, Cd, In, Sn, Sb, Te, Hf, Ta, W, Re, Os, Ir, Pt, Au, TI, Pb, Bi, Po and alloys or combinations thereof, and/or wherein carbon is selected from the group consisting of activated carbon, carbon black, graphitic carbon, carbon beads, carbon fibers, carbon microfibers, fullerenic carbons, carbon nanotubes (CNTs), multi-walled carbon nanotubes (MWNTs), single-walled carbon nanotubes (SWNTs), graphene sheets or aggregates of graphene sheets, and materials comprising fullerenic fragments and any combination thereof.

14. (canceled)

15. (canceled)

16. (canceled)

17. (canceled)

18. The electrode according to claim 1, wherein the conductive particles in at least one of the first operating mode and the second operating mode are present in a form of agglomerates.

19. (canceled)

20. The electrode according to claim 18, wherein the aspect ratio of the conductive particles or the agglomerates thereof ranges from about 2:1 to about 10:1.

21. The electrode according to claim 1, wherein the conductive particles have an activated surface, wherein the surface of the conductive particles is activated by a method selected from the group consisting of acid treatment, plasma treatment, UV radiation, addition of functional surface groups, and combinations thereof.

22. (canceled)

23. The electrode according to claim 1, wherein the conductive particles have a roughness ranging from about 10 nm to about 10 μm.

24. (canceled)

25. (canceled)

26. (canceled)

27. (canceled)

28. The electrode according to claim 1, wherein the electric conductivity of the electrode is lower than about 10 mS/cm in the first operating mode and/or is at least about 100 mS/cm in the second operating mode.

29. (canceled)

30. (canceled)

31. The electrode according to claim 1, wherein the electrode compartment comprises copper particles, wherein the mean particle size of said copper particles ranges from about 1 to about 150 μm and wherein the fluidizing medium comprises an electrolyte having an ionic conductivity ranging from about 0.1 to about 200 mS/cm; or wherein the electrode compartment comprises zinc particles, wherein the mean particle size of said zinc particles ranges from about 20 to about 200 μm.

32. (canceled)

33. (canceled)

34. An electrochemical device, comprising:
a first current collector;
a second current collector;
at least one separator; and
at least one intermittently-flowable electrode according to claim 1, positioned between said first or second current collectors and the separator; and
at least one tube in fluid flow connection with the electrode compartment.

35. (canceled)

36. An energy storage and/or harvesting system comprising the electrochemical device according to claim 34; and at least one external storage tank, being in fluid flow connection with the at least one tube, wherein the storage tank is configured to store the conductive particles and/or the fluidizing medium and to deliver the conductive particles and/or the fluidizing medium to the at least one tube prior to the electrochemical operation of the system.

37. (canceled)

38. (canceled)

39. (canceled)

40. (canceled)

41. The energy storage system according to claim 36, wherein the energy storage and/or harvesting system is configured in a form selected from a redox flow battery (RFB), electrochemical flow supercapacitor or a capacitive mixing system and wherein the RFB is selected from the group consisting of a zinc-bromine flow battery, hydrogen-bromine, quinone-bromine, vanadium-bromine, all quinone, all-iron flow battery, vanadium redox flow battery, lithium-ion flow battery, lithium-sulfur, sodium ion, sodium-sulfur flow battery, lead-acid flow battery, and nickel metal hydride flow battery.

42. (canceled)

43. A water desalination system comprising the device according to claim 34, wherein the water desalination system is configured in a form of a Capacitive Deionization (CDI) system, and wherein the separator is an ion-permeable membrane and the system further comprises a feed tank comprising a mixing vessel, which is in fluid flow connection with the at least one tube and is configured to mix the fluidizing medium with the conductive particles.

44. (canceled)

45. (canceled)

46. A method of operating the intermittently-flowable electrode according to a claim 1, the method comprising:
flowing the liquid fluidizing medium through the electrode compartment;
increasing a superficial velocity of the liquid fluidizing medium above the minimum fluidization velocity of the electrode, thereby inducing electrode operation in the first operating mode;
and/or reducing the superficial velocity of the liquid fluidizing medium below the minimum fluidization velocity of the electrode, thereby inducing electrode operation in the second operating mode; and
applying electrical potential to the intermittently-flowable electrode.

47. (canceled)

48. The method according to claim 46, further comprising applying mechanical vibration to the electrode compartment following electrode operation in the second operating mode.
